(19) United States
(12) Patent Application Publication
(10) Pub. No.: US 2026/0136324 A1
(43) Pub. Date: May 14, 2026

(54) SYSTEMS AND METHODS FOR DEVICE-TO-DEVICE COMMUNICATIONS

(71) Applicant: ZTE CORPORATION, Shenzhen (CN)

(72) Inventors: Mengzhen LI, Shenzhen (CN); Chuangxin JIANG, Shenzhen (CN); Qi YANG, Shenzhen (CN); Yu PAN, Shenzhen (CN); Youxiong LU, Shenzhen (CN); Cong WANG, Shenzhen (CN); Junpeng LOU, Shenzhen (CN); Weimin XING, Shenzhen (CN)

(73) Assignee: ZTE CORPORATION, Shenzhen (CN)

(21) Appl. No.: 19/443,489

(22) Filed: Jan. 8, 2026

Related U.S. Application Data
(63) Continuation of application No. PCT/CN2023/110406, filed on Jul. 31, 2023.

(51) Int. Cl. H04W 64/00; H04L 5/00; H04W 72/0457; H04W 72/231; H04W 72/25; H04W 76/20; H04W 92/18

(52) U.S. Cl. CPC H04W 64/00; H04L 5/0051; H04W 72/0457; H04W 72/231; H04W 72/25; H04W 76/20; H04W 92/18

(57) ABSTRACT

The present disclosure relates to systems, apparatuses, methods, and non-transitory computer-readable media for determining, by a first wireless communication device, configuration for a SL positioning-related transmission and communicating, by the first wireless communication device with a second wireless communication device, the SL positioning-related transmission, wherein the SL positioning-related transmission includes at least one of a Sidelink Positioning Reference Signal (SL-PRS), a Physical Shared Control Channel (PSCCH) corresponding to the SL PRS, or a Demodulation Reference Signal (DMRS).

### CROSS-REFERENCE TO RELATED APPLICATION

This application claims the benefit of priority under 35 U.S.C. § 120 as a continuation of International Patent Application No. PCT/CN2023/110406, filed on Jul. 31, 2023, the disclosure of which is incorporated herein by reference in its entirety.

### TECHNICAL FIELD

The disclosure relates generally to wireless communications and, more particularly, to device-to-device communications.

### BACKGROUND

Sidelink (SL) communication refers to wireless radio communication between two or more User Equipments (UEs). In this type of communications, two or more UEs that are geographically proximate to each other can communicate without being routed to a network (e.g. Base Station (BS)) or a core network. Data transmissions in SL communications are thus different from typical cellular network communications that include transmitting data to a BS and receiving data from a BS. In SL communications, data is transmitted directly from a source UE to a target UE through, for example the Unified Air Interface (e.g., PC5 interface) without passing through a BS.

In conventional SL positioning mechanisms, target requirement Sub-meter Accuracy (Set B) cannot be achieved. SL Positioning Reference Signal (PRS) bandwidth is essential for positioning accuracy. For example, up to 100 MHz is recommended for SL positioning in Frequency Range 1 (FR1). However, currently only Intelligent Transport System (ITS) band and licensed spectrum in FR1 are supported for Rel-18 SL positioning. The available bandwidth resources of ITS and FR1 are less than 40 MHz.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with some arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to systems, apparatuses, methods, and non-transitory computer-readable media for determining, by a first wireless communication device, configuration for a SL positioning-related transmission and communicating, by the first wireless communication device with a second wireless communication device, the SL positioning-related transmission, wherein the SL positioning-related transmission includes at least one of a Sidelink Positioning Reference Signal (SL-PRS), a Physical Shared Control Channel (PSCCH) corresponding to the SL PRS, or a Demodulation Reference Signal (DMRS).

Some arrangements of the present disclosure relate to systems, methods, apparatuses, and non-transitory computer-readable media relating to systems, apparatuses, methods, and non-transitory computer-readable media for receiving, by a wireless communication device from a Location Management Function (LMF), configuration for a Downlink Positioning Reference Signal (DL-PRS) and receiving, by a wireless communication device from a Base Station (BS), the Downlink Positioning Reference Signal (DL-PRS) according to the configuration.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication system, according to some arrangements.

FIG. 1B is a diagram illustrating a block diagram of an example wireless communication system for transmitting and receiving downlink, uplink, and/or SL communication signals, according to some arrangements.

FIG. 2 illustrates an example scenario for SL communications, according to some arrangements.

FIG. 3 is a schematic diagram illustrating candidate resource selection for transmitting SL-PRS, according to some arrangements.

FIG. 4 is a flowchart diagram illustrating an example method for communicating SL positioning-related transmission, according to some arrangements.

FIG. 5 is a diagram illustrating an example configuration of SL positioning resource pools in both licensed band and unlicensed band, according to some arrangements.

FIG. 6 is a diagram illustrating an example configuration of SL positioning resource pools in both licensed band and unlicensed band, according to some arrangements.

FIG. 7 is a diagram illustrating an example SL-PRS resource pool that includes 2 RB sets with a guard band in between, according to some arrangements.

FIG. 8 is a diagram illustrating interlace RB-based PSCCH transmission where each PSCCH transmission for SL positioning occupies 1 common interlace and M dedicated PRB(s), according to some arrangements.

FIG. 9 is a diagram illustrating an example PRB with an RE-level DFT vector for each PSCCH resource and associated DMRS, according to some arrangements.

FIG. 10 is a diagram illustrating RE-level FD-OCC within a PRB bundle for PSCCH in SL-U positioning, according to some arrangements.

FIG. 11 is a diagram illustrating RE-level FD-OCC for a PRB for PSCCH in SL-U positioning, according to some arrangements.

FIG. 12 is a diagram illustrating RE-level FD-OCC for a PRB for PSCCH in SL-U positioning, according to some arrangements.

FIG. 13 is a diagram illustrating an PRB configured for TD-OCC for PSCCH in SL-U positioning, according to some arrangements.

FIG. 14 is a diagram illustrating an RB set, according to some arrangements.

FIG. 15 is a diagram illustrating an RB set configured for PSCCH in SL-U positioning, according to some arrangements.

FIG. 16 is a diagram illustrating a PRB configured for PSCCH in SL-U positioning, according to some arrangements.

FIG. 17 is a diagram illustrating RB sets that are resources used to transmit PSCCH and SL-PRS, according to some arrangements.

FIG. 18 is a diagram illustrating TDM-based multiplexing of SL-PRS from different UEs in a slot, according to some arrangements.

FIG. 19 is a diagram illustrating resources for transmitting SL-PRS with a gap introduced between two adjacent SL-PRS resources, according to some arrangements.

FIG. 20 is a diagram illustrating example resources in which one or more TDMed SL-PRS resources are disabled to avoid potential LBT failure, according to some arrangements.

FIG. 21 is a diagram illustrating example resources including a slot in which multiple SL-PRS resources are configured, according to some arrangements.

FIG. 22 is a diagram illustrating example time-domain resource with a 2210 for LBT between two SCI+SL-PRS resources for two respective UEs, according to some arrangements.

FIG. 23 is a diagram illustrating an LBT failure of one UE caused by another UE's SL-PRS and/or PSCCH transmission, according to some arrangements.

FIG. 24 is a diagram illustrating an example configuration of time-domain resources of UEs for transmitting SL-PRS and/or PSCCH transmissions, according to some arrangements.

FIG. 25 is a diagram illustrating an example time window for transmitting a SL positioning-related transmission by a plurality of UEs, according to some arrangements.

FIG. 26 illustrates an example configuration of multiple transmission occasions for one SL-PRS resource, according to some arrangements.

FIG. 27 is a flowchart diagram illustrating an example method for performing power saving for NR-U, according to some arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

In some arrangements, wireless communications can be performed on carriers, frequency bands, and/or frequency spectrums. Some carriers are licensed carriers as they are licensed by a government or another authoritative entity to a service provider for exclusive use. Some carriers are unlicensed carriers, which are not licensed by any government or authoritative entities for exclusive use. Two or more service providers can operate in an unlicensed carrier. Currently, UEs can communicate directly with each other (e.g., without doing so using a base station) on the licensed carriers. No schemes have been provided for UEs to communicate with each other on unlicensed carriers.

In some arrangements, a licensed carrier refers to a carrier, frequency band, or spectrum that is licensed by a government or an authoritative entity, such as the Federal Communications Commission (FCC) in the United States and the European Telecommunications Standards Institute (ETSI) in Europe, to a service provider for exclusive use. An unlicensed carrier (or shared spectrum) refers to a carrier, frequency band, or spectrum that is not licensed by a government or another authoritative entity. Two or more service providers can operate in the unlicensed carrier.

The arrangements disclosed herein relate to SL positioning, including channel access procedure and channel design, in unlicensed band (shared spectrum). Signaling procedures for sidelink positioning are described herein.

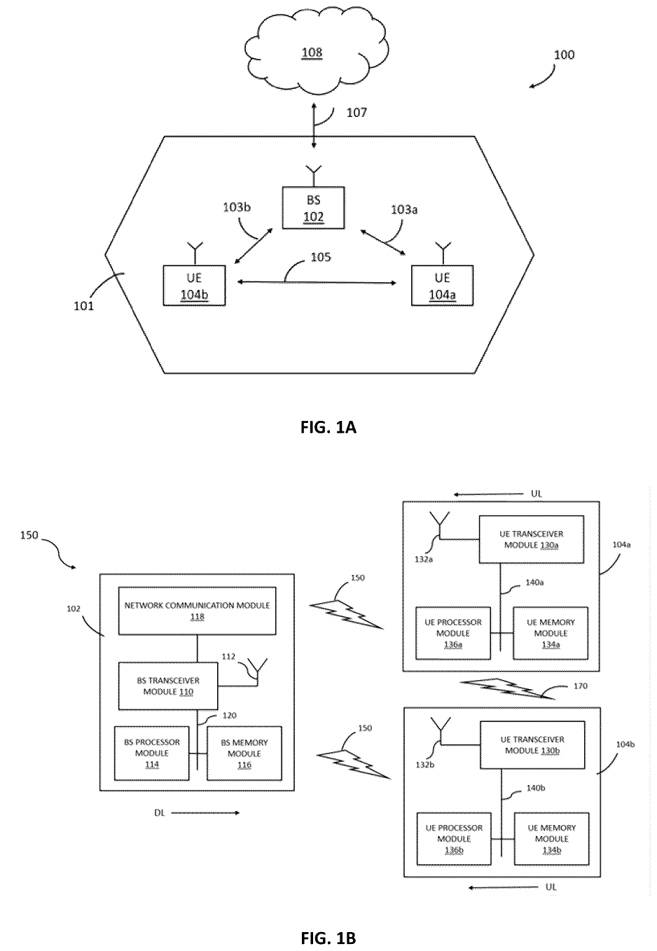

Referring to FIG. 1A, an example wireless communication system 100 is shown. The wireless communication system 100 illustrates a group communication within a cellular network. In a wireless communication system, a network side communication node or a network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In some examples, a UE can be a vehicle UE, a pedestrian UE, a Road-Side UE (RSU), a Positioning Reference Unit (PRU), and so on. A UE described herein can implement the methods described herein with or without a known location. In FIG. 1A, a network side and a terminal side communication node are represented by a network 102 and UEs 104a and 104b, respectively. In some arrangements, the network 102 and UEs 104a/104b are sometimes referred to as “wireless communication node” and “wireless communication device,” respectively. Such communication nodes/devices can perform wireless communications.

In the illustrated arrangement of FIG. 1A, the network 102 can define a cell 101 in which the UEs 104a and 104b are located. The UEs 104a and/or 104b can be moving or remain stationary within a coverage of the cell 101. The UE 104a can communicate with the network 102 via a communication channel 103a. Similarly, the UE 104b can communicate with the network 102 via a communication channel 103b. In addition, the UEs 104a and 104b can communicate with each other via a communication channel 105. The communication channels 103a and 104b between a respective UE and the network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The network 102 is connected to Core Network (CN) 108 through an external interface 107, e.g., an Iu interface.

In some examples, a remote UE (e.g., the UE 104b) that does not directly communicate with the network 102 or the CN 108 (e.g., the communication channel link 103b is not established) communicates indirectly with the network 102 and the CN 108 using the SL communication channel 105 via a relay UE (e.g., the UE 104a), which can directly communicate with the network 102 and the CN 108 or indirectly communicate with the network 102 and the CN 108 via another relay UE that can directly communicate with the network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication system 100 of FIG. 1A, as described above.

The system generally includes the network 102 and UEs 104a and 104b, as described in FIG. 1A. The network 102 includes a network transceiver module 110, a network antenna 112, a network memory module 116, a network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The network 102 communicates with the UEs 104a and 104b via one or more of a communication channel 150, which can be any wireless channel or other medium known in the art suitable for transmission of data as described herein.

The system can further include any number of modules other than the modules shown in FIG. 1B. Those skilled in the art will understand that the various illustrative blocks, modules, circuits, and processing logic described in connection with the arrangements disclosed herein can be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein can implement such functionality in a suitable manner for each particular application, but such implementation decisions should not be interpreted as limiting the scope of the present disclosure.

A wireless transmission from an antenna of one of the UEs 104a and 104b to an antenna of the network 102 is known as an uplink transmission, and a wireless transmission from an antenna of the network 102 to an antenna of one of the UEs 104a and 104b is known as a downlink transmission. In accordance with some arrangements, each of the UE transceiver modules 130a and 130b can be referred to herein as an uplink transceiver, or UE transceiver. The uplink transceiver can include a transmitter and receiver circuitry that are each coupled to the respective antenna 132a and 132b. A duplex switch can in some examples couple the uplink transmitter or receiver to the uplink antenna in time duplex fashion. Similarly, the network transceiver module 110 can be herein referred to as a downlink transceiver, or network transceiver. The downlink transceiver can include RF transmitter and receiver circuitry that are each coupled to the antenna 112. A downlink duplex switch can in some examples couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the network transceiver 110 can be configured to support alternate, or additional, wireless data communication protocols, including future standards or variations thereof.

The processor modules 136a and 136b and 114 can be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor can be realized as a microprocessor, a controller, a microcontroller, a state machine, or the like. A processor can also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein can be embodied directly in hardware, in firmware, in a software module executed by processor modules 114 and 136a and 136b, respectively, or in any practical combination thereof. The memory modules 116 and 134a and 134b can be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b can be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b can also be integrated into their respective processor modules 114, 136a, and 136b. In some arrangements, the memory modules 116, 134a, and 134b can each include a cache memory for storing temporary variables or other intermediate information during execution of instructions to be executed by processor modules 116, 134a, and 134b, respectively. Memory modules 116, 134a, and 134b can also each include non-volatile memory for storing instructions to be executed by the processor modules 114 and 136a and 136b, respectively.

The network interface 118 generally represents the hardware, software, firmware, processing logic, and/or other components of the network 102 that enable bi-directional communication between network transceiver 110 and other network components and communication nodes configured to communication with the network 102. For example, the network interface 118 can be configured to support internet or WiMAX traffic. In a typical deployment, without limitation, the network interface 118 provides an 802.3 Ethernet interface such that network transceiver 110 can communicate with a conventional Ethernet based computer network. In this manner, the network interface 118 can include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the network 102 to communicate with other network s or core network over a wired or wireless connection.

In some arrangements, each of the UEs 104a and 104b can operate in a hybrid communication network in which the UE communicates with the network 102, and with other UEs, e.g., between 104a and 104b. As described in further detail below, the UEs 104a and 104b support SL communications with other UE's as well as downlink/uplink communications between the network 102 and the UEs 104a and 104b. In general, the SL communication allows the UEs 104a and 104b to establish a direct communication link with each other, or with other UEs from different cells, without requiring the network 102 to relay data between UEs.

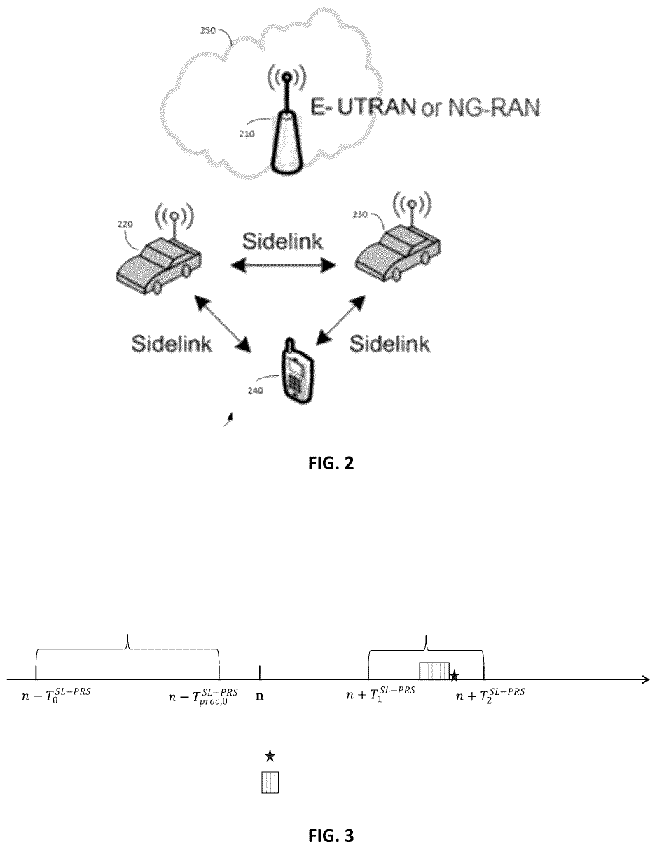

FIG. 2 is a diagram illustrating an example system 200 for SL communication, according to some arrangements. As shown in FIG. 2, a network 210 (such as network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX or Tx) UE, and the UE that is receiving said data is referred to as the reception (RX or Rx) UE.

In some examples, for SL positioning/ranging in licensed band or ITS band, both scheme 1 resource allocation and scheme 2 resource allocation are supported. Scheme 1 resource allocation can also be seen as network-centric operation and SL-PRS resource allocation in which the SL-PRS resources to be transmitted are configured/scheduled by the BS (e.g., gNB) via either dynamic grant, configured grant type 1, or configured grant type 2. Scheme 2 is a UE autonomous SL-PRS resource allocation mode where SL-PRS resources to be transmitted are based on either/both sensing results, Inter-UE Coordination (IUC) information, or/and random resource selection.

In 5G New Radio-Unlicensed (NR-U) or SL-Unlicensed (SL-U), the main restriction of using shared or unlicensed spectrum is that devices including BS, UE, or other non-3GPP users (e.g., WIFI devices) can access to a channel only after a Listen Before Talk (LBT) success or if the Clear Channel Assessment (CCA) results show that the channel is idle. In some cases, a channel access procedure is a procedure based on sensing that evaluates the availability of a channel for performing transmissions.

FR1 NR-U includes two CCA modes. A first CCA mode includes Load-Based Equipment (LBE) or a dynamic channel access mode. For either Downlink (DL) channel access and/or Uplink (UL) channel access, Type 1 includes CCA time before a transmission is random, and Type 2 includes CCA time before a transmission is deterministic. Type 2 further includes Type 2A, Type 2B, and Type 2C. There are differences between DL channel access and UL channel access, e.g., the Channel Access Priority Class (CAPC) tables for DL type 1 channel access and type 1 UL channel access are different.

A second CCA mode includes Frame-Based Equipment (FBE) or semi-static channel access mode, in which the time-domain resources for FBE mode is periodic. One Fixed Frame Period (FFP) includes a Channel Occupancy Time (COT) and idle period. The idle period is located at the end of an FFP.

In some arrangements a UE performs a channel access scheme referred to as LBT before performing data transmission on an unlicensed carrier. In the LBT procedure, the UE monitors a channel in the unlicensed carrier for an interval of time. In response to determining that the LBT procedure is successful, the UE can occupy the channel in the unlicensed carrier for an interval of time referred to as COT. The LBT procedure includes initial LBT procedure and non-initial LBT procedure. The non-initial LBT procedure is performed within the COT.

In some arrangements, the CAPC table described herein is used for Type 1 channel access. For example, the CAPC table defines the association relationship between CAPC (p) and {mₚ, CW_{min, p}, CW_{max, p}, T_{m cot, p}, allowed CWₚ sizes}. In some examples, mₚ refers to the defer duration T_{d} which includes duration T_{f}=16 μs immediately followed by mₚ consecutive sensing slot durations Tₛₗ. T_{f} includes an idle sensing slot duration Tₛₗ at start of T_{f}. For CW_{min, p}, CW_{max, p}, allowed CWₚ sizes, CWₚ is the size of the Contention Window (CW), where CW_{min, p}≤CWₚ≤CW_{max, p}. CWₚ adjustment is supported for DL/UL channel access and SL channel access for communication based on the allowed CWₚ sizes associated with a CAPC p. With respect to T_{m cot, p}, a UE or BS (e.g., eNB or gNB) does not transmit on a channel for a COT that exceeds T_{m cot, p} where the channel access procedures are performed based on a CAPC p associated with the transmissions of the UE or BS.

A channel in NR-U or SL-U refers to a carrier or a part of a carrier including a contiguous set of frequency-domain resources (e.g., Resource Blocks (RBs)) on which a channel access procedure is performed in a shared spectrum. In some examples, one channel is associated with one RB set. In the examples in which the service requests wide bandwidth (e.g., including two or more RB sets), the device applies the multi-channel access procedure. DL type A and type B multi-channel access procedure and UL multi-channel access procedures can be implemented.

In some arrangements, an RB set is configured in parameter ServingCellConfig for DL/UL channel access via defining the length and location of guard bands (zero-size guard band is also allowed).

For SL-U positioning, a UE can transmit Physical Shared Control Channel (PSCCH) and its corresponding SL PRS in a shared spectrum. An initiating UE refers to a UE that initiates a channel access procedure and occupy a COT. The initiating UE is expected to transmit SL positioning-related data in this COT. From initiating UE's perspective, the initiating UE performs channel access procedure based on sensing/LBT that evaluates the availability of a channel for SL positioning-related transmission. The COT occupied by the initiating UE can be shared to other UE(s) for other UE(s)'s SL positioning transmission purpose.

Both dynamic channel access and semi-static channel access can be supported for SL positioning in shared spectrum. From the initiating UE's perspective, dynamic channel access procedure is performed by a UE where the time duration spanned by the sensing slots that are sensed to be idle before a SL transmission is random or fixed based on dynamic SL positioning transmission demands. For semi-persistent channel access, the opportunity of COT is periodic.

For SL positioning/ranging in unlicensed band, a UE cannot directly transmit SL-PRS resources based on either network's configuration/scheduling or UE's autonomous resource selection (sensing, IUC, random resource selection) without LBT procedure. FIG. 3 is a schematic diagram illustrating candidate resource selection for transmitting SL-PRS, according to some arrangements. In scheme 2, a UE first selects candidate resources within a selection window 320 based on sensing results performed within the sensing window 310. The UE can transmit the selected SL-PRS resource(s) 330 only within a COT. In other words, a selected or configured SL-PRS resource cannot be transmitted without success of the LBT procedure 340. Either this UE initiates a COT or shares a COT with other UEs or a BS.

The basic unit for sensing is a sensing slot with a duration Tₛₗ=9 μs. The sensing slot duration Tₛₗ is considered to be idle if a UE senses the channel during the sensing slot duration and determines that the detected power for at least 4 μs within the sensing slot duration is less than energy detection threshold X_{Thresh}. Otherwise, the sensing slot duration Tₛₗ is considered to be busy. The arrangements disclosed herein use a LBT time duration or CCA time to represent the time duration spanned by the sensing slots that are sensed to be idle before a SL transmission.

The COT refers to the total time for which UE and any UE(s)/BS sharing the channel occupancy perform transmission(s) on a channel after a UE performs the corresponding channel access procedures. For determining the COT, if a transmission gap is less than or equal to 25 μs, the gap duration is counted in the COT.

A SL transmission burst for SL positioning is defined as a set of SL transmissions for SL positioning (e.g. SL-PRS transmission) from a UE without any gaps greater than 16 μs. Transmissions from a UE separated by a gap of more than 16 μs are considered as separate SL transmission bursts. A UE can transmit SL transmission(s) after a gap of up to 16 μs within a SL transmission burst without sensing the corresponding channel(s) for availability.

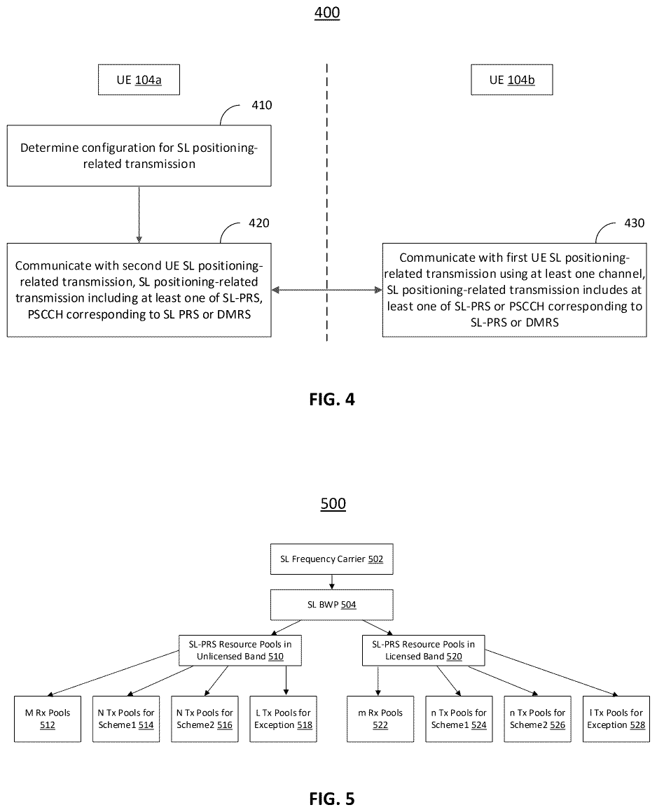

FIG. 4 is a flowchart diagram illustrating an example method 400 for communicating SL positioning-related transmission, according to some arrangements. The method 400 can be performed using the system 100.

At 410, a first UE (e.g., the UE 104a) determines configuration for the SL positioning related transmission. In some examples, the SL-positioning related transmission includes at least one of SL-PRS, PSCCH, or a Demodulation Reference Signal (DMRS). In some examples, the first UE can receive the configuration for the SL positioning related transmission from another node or entity such as another UE (e.g., the second UE, the UE 104b), the BS 102, or a Location Management Function (LMF). In some examples, the first UE can determine the configuration for the SL positioning related transmission by itself according to a suitable set of rules or algorithms, without directly and explicitly receiving it from another node or entity.

At 420, the first UE communicates with (e.g., sends or transmits to) the second UE (e.g., the UE 104b) the SL positioning-related transmission. At 430, the second UE communicates with (e.g., receives from) the first UE the SL positioning-related transmission.

In some arrangements, the configuration is received by the first UE from at least one of the BS 102 via at least one of Resource Control (RRC) signaling, a Downlink Control Information (DCI), or a Medium Access Control (MAC) Control Element (CE). In some arrangements, the configuration is received by the first UE from a Location Management Function (LMF) via Long Term Evolution Positioning Protocol (LPP). In some examples, the configuration includes an idle period is received by the first UE from the second UE or a third UE via at least one of Sidelink Positioning Protocol (SLPP), PC5-RRC signaling, SL MAC CE, or Sidelink Control Information (SCI). The third UE can be any UE different from the first and second UEs, and can be referred to as a server UE. The server UE can be used for positioning method determination, anchor UE selection, assistance distribution and/or location calculation in resource allocation scheme 2. The server UE can be used to deliver CAPC config to the Tx UE. In some examples, either the anchor UE or target UE or any UEs can be the server UE. In some arrangements, the CAPC is received by the first UE from an LMF via LPP.

Some arrangements, relate to configuring SL positioning resource pools (e.g., a dedicated resource pool, shared resource pool, or so on) in unlicensed or shared band. In some examples, the parameter FreqConfigCommon specifies the cell-specific configuration information on one particular carrier frequency for either/both SL positioning or/and SL communication. The parameter FreqConfig specifies the dedicated configuration information on one particular carrier frequency for either/both SL positioning or/and SL communication. Moreover, the maximum number of BWPs for SL positioning for each carrier frequency can be configured to 4. The SL positioning resource pools cover both dedicated resource pools and shared resource pools.

A channel in NR-U or SL-U refers to a carrier or a part of a carrier including a contiguous set of frequency-domain resources (e.g., Resource Blocks (RBs)) on which a channel access procedure is performed in a shared spectrum. In some examples, one channel is associated with one RB set. In the examples in which the service requests wide bandwidth (e.g., including two or more RB sets), the device applies the multi-channel access procedure. DL type A and type B multi-channel access procedure and UL multi-channel access procedures can be implemented.

In some examples in which the UE cannot receive the network's configuration for SL positioning, pre-configuration is used. For example, the parameter FreqConfigCommon is applicable for both SL positioning and SL-U positioning. Then this carrier includes both SL positioning resource pools in licensed band (e.g., ITS band) and SL positioning resource pools in unlicensed band. In some examples, two parameters FreqConfigCommon are defined for SL positioning and SL-U positioning respectively.

In some arrangements, the configuration for SL-U positioning can be indicated by the network. In some examples, the BS 102 can indicate using common signaling some common configurations (e.g., FreqConfigCommon) of SL positioning for all UEs via System Information Block (SIB). In some examples, the parameter FreqConfigCommon is applicable for both SL positioning and SL-U positioning. Then this carrier includes both SL positioning resource pools in licensed band (e.g., ITS band) and SL positioning resource pools in unlicensed band. In some examples, two parameters FreqConfigCommon are defined for SL positioning and SL-U positioning respectively.

In some arrangements, the BS 102 can transmit UE-specific configuration of SL positioning to a certain UE using dedicated signaling. In some examples, the parameter FreqConfig is applicable for both SL positioning and SL-U positioning. Then this carrier includes both SL positioning resource pools in licensed band (e.g., ITS band) and SL positioning resource pools in unlicensed band. In some examples, two parameters FreqConfig are defined for SL positioning and SL-U positioning respectively.

FIG. 5 is a diagram illustrating an example configuration 500 of SL positioning resource pools in both licensed band and unlicensed band, according to some arrangements. As shown in FIG. 5, the SL frequency carrier 502 can be configured to include the SL Bandwidth Part (BWP) 504, which is configured to include the SL-PRS pools in unlicensed band 510 and the SL-PRS resource pools in licensed band 520. The SL-PRS pools in unlicensed band 510 includes M Rx pools 512, N Tx pools for scheme1 514, N Tx pools for Scheme2 516, L Tx pools for exception 518. The SL-PRS pools in licensed band 520 includes m Rx pools 522, n Tx pools for scheme1 524, n Tx pools for Scheme2 526, 1 Tx pools for exception 528. Regardless of whether SL communication and SL positioning use the same carrier frequency, SL positioning and SL-U positioning use the same carriers. Each carrier includes one or more SL-BWP config where resource pools can be configured within a SL-BWP. PSCCH and SL-PRS can be configured within each resource pool. In some arrangements, the configuration in the method 400 designates at least one carrier for both SL positioning and SL-U positioning, each of the at least one carrier includes one or more SL-BWPs, at least one resource pool configured with a SL-Bandwidth Part (SL-BWP), and a resource for transmitting each of the at least one of the SL-PRS or the PSCCH within each of the at least one resource pool.

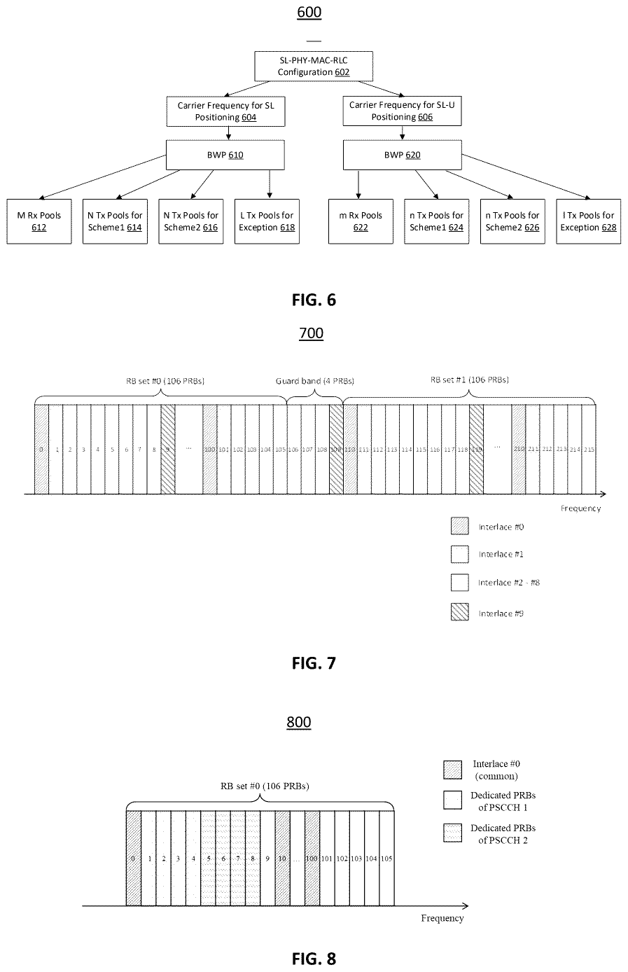

FIG. 6 is a diagram illustrating an example configuration 600 of SL positioning resource pools in both licensed band and unlicensed band, according to some arrangements. As shown in FIG. 6, the SL-PHY-MAC-RLC configuration 602 includes the carrier frequency for SL positioning 604 and the carrier frequency for SL-U positioning 606. The carrier frequency for SL positioning 604 includes BWP 610, which is configured to include M Rx pools 612, N Tx pools for scheme1 614, N Tx pools for Scheme2 616, L Tx pools for exception 618. The carrier frequency for SL positioning 604 includes BWP 620, which is configured to include m Rx pools 622, n Tx pools for scheme1 624, n Tx pools for Scheme2 626, and 1 Tx pools for exception 628. Regardless of whether SL communication and SL positioning use the same carrier frequency, SL positioning and SL-U positioning use different carriers. Each carrier includes one or more SL-BWP config where resource pools can be configured within a SL-BWP. PSCCH and SL-PRS can be configured within each resource pool. In some arrangements, the configuration in the method 400 designates a first carrier for SL positioning and a second carrier for SL-U positioning (the first carrier is different from the second carrier), each of the first carrier and the second carrier includes one or more SL-BWPs, at least one resource pool configured with a SL-BWP, and a resource for transmitting each of the at least one of the SL-PRS or the PSCCH within each of the at least one resource pool.

In some examples, at least one or more of the following parameters can be configured per BWP: resource pool(s) for SL positioning, a SL-BWP can be configured or pre-configured with either contiguous RB-based or interlace RB-based for PSCCH transmission, or a candidate starting symbol of PSCCH is configured or pre-configured per BWP, Automatic Gain control (AGC) symbol numbers of a slot, AGC symbol location of a slot, gap symbol numbers of a slot, gap symbol location of a slot where the gap symbol can either be used for transmission-reception turnaround time or used as LBT gap for reducing block issues.

Some arrangements relate to supporting interlace RB-based SL-PRS transmission. For SL-PRS transmission, given the fact that comb-based sequence design is already agreed for SL-PRS, there can be no significant needs to support interlace RB-based SL-PRS transmission. In other words, in SL-U positioning, interlace RB-based SL-PRS transmission is not supported.

In some examples, if interlace RB-based SL-PRS transmission is supported, then by default each SL-PRS resource occupies all interlaces of a resource pool and on a basis of that comb-based structure of SL-PRS is applied. In some arrangements, the configuration designates that each resource for transmitting the SL-PRS occupies all interlaced RBs of a resource pool. The SL-PRS has a comb-based structure.

In some arrangements, one or more frequency-domain resource allocation granularities can be applied for SL-U positioning. For example, frequency-domain resource allocation granularity can be resource pool. In other words, the bandwidth of SL-PRS is the same as that of its resource pool. In some examples, frequency-domain resource allocation granularity can be SL-PRS resource set. In some examples, frequency domain resource allocation granularity can be SL-PRS resource. One sub-channel can include one or multiple interlaces.

Some arrangements relate to configurations for transmitting PSCCH that includes 1 common interlace and M dedicated PRBs. PSCCH (which is associated with or mapped to SL-PRS) mapping to frequency resources on resource pool configuration is based on one or more of whether both or only one of interlace RB-based transmission and contiguous RB-based transmission is supported, whether and how to avoid PSCCH capacity that is too small, the multi-channel case, whether PSCCH of SL positioning can use guard band to transmit, how to meet Occupied Channel Bandwidth (OCB) and Power Spectral Density (PSD) requirement.

In some examples, one SL-PRS resource pool (e.g., dedicated SL-PRS resource pool, shared resource pool) at least can be configured or pre-configured to include integer number of RB sets with or without guard band(s). FIG. 7 is a diagram illustrating an example SL-PRS resource pool 700 that includes 2 RB sets #0 and #1, with a guard band in between, according to some arrangements. The RB set #0 includes 106 PRBs. The RB set #1 includes 106 PRBs. The guard band includes 4 PRBs. The number of RB interlaces is determined based on Subcarrier Spacing (SCS). The PRBs in the RB set #0, the RB set #1, and guard band include PRBs that belong to interlaces #0, #1, #2-8, and #9 as shown.

In some arrangements, interlace RB-based PSCCH transmission is configured or pre-configured where each PSCCH transmission for SL positioning occupies 1 common interlace/subchannel and M dedicated PRB(s). FIG. 8 is a diagram illustrating interlace RB-based PSCCH transmission where each PSCCH transmission for SL positioning occupies 1 common interlace (e.g., interlace #0) and M dedicated PRB(s), according to some arrangements. The RB set #0 shown in FIG. 8 has 106 PRBs, which can belong to the interlace #0, the dedicated PRBs of PSCCH 1 and the dedicated PRBs of PSCCH 2. In some examples, the common interlace (interlace #0 as shown in FIG. 8) is used to meet OCB and PSD requirement and the M dedicated PRBs is meant to carry SCI which transports SL-U positioning scheduling information. One or multiple guard band PRBs between common PRB and M dedicated PRBs can be configured or pre-configured. M can be configured or pre-configured by the BS 102 (e.g., via RRC, DCI, MAC CE, SIB), the LMF (via LPP), or another UE such as the second or third UEs (via SLPP). The candidate value of M can at least include one or more of: 1, 2, 5, 10, 12, 15, 20, 25. M dedicated PRBs can be located in the same RB set.

As shown in FIG. 8, one PSCCH resource includes 4 dedicated PRBs in RB set #0. In some examples, M dedicated PRBs can be on the same interlace or same interlaces. For example, PSCCH resource 1 includes the lowest 5 PRBs of interlace #1 and PSCCH resource 2 includes the highest 5 PRBs of the same interlace #1.

In some examples, M dedicated PRBs can include one or multiple interlaces. To increase PSCCH capacity, a vector with its length and index can be configured to the UE 104a per PSCCH resource to assure multiple PSCCH resources multiplexed in the same interlace(s) are orthogonal. For example, FD-OCC, TD-OCC, Discrete Fourier Transform (DFT) shift (cyclic shift) vector, and so on can be used.

In some examples, there is a mapping relationship between PSCCH's M dedicated PRBs and one or more SL-PRS resource(s). The mapping can be configured or pre-configured by higher layers. For example, the mapping can be defined in each SL positioning resource pool. multiple “one PSCCH and associated one or more SL-PRS resources” pairs or multiple “one or more PSCCH and associated one SL-PRS resource” pairs can be configured or pre-configured, the mapping at least includes one of: Starting symbol of SCI/PSCCH, number of symbols of SCI/PSCCH, starting PRB of SCI/PSCCH, PRB number of SCI/PSCCH, the location and number of dedicated PRBs, occupied interlace index, occupied sub-channel index, RB set index, a vector type, a vector length, a vector index, starting symbol of associated SL-PRS, number of symbols of associated SL-PRS, starting PRB of associated SL-PRS, comb size of associated SL-PRS, resource bandwidth of associated SL-PRS.

In some examples, the UE 104a can receive PSCCH resource configuration including M dedicated PRBs related configuration (e.g., the value of M, the mapping between M dedicated PRBs and SL-PRS resource) from another UE (e.g., a second UE or a third UE) via SLPP. For example, server UE can configure multiple UEs' PSCCH multiplexing by indicating different M dedicated PRBs for PSCCH resource to different UEs.

In some examples, the UE 104a can receive PSCCH resource configuration including M dedicated PRBs related configuration (e.g., the value of M, the mapping between M dedicated PRBs and SL-PRS resource) from LMF via LPP. For example, the LMF can configure PSCCH resources for multiple UEs. In some examples, the LMF can send a request message via New Radio Positioning Protocol A (NRPPa) to trigger the BS(s) to provide the SL-PRS configurations and its associated PSCCH configuration including the mapping between PSCCH and SL-PRS. The BS 102 can send the PSCCH and SL-PRS configurations of different UEs to LMF. In order to increase PSCCH capacity, the LMF can provide recommended PSCCH configuration including M dedicated PRBs to gNB via NRPPa. In this case, the UE 104a can receive PSCCH related configuration from the BS 102. In some examples, the LMF can provide PSCCH configuration including M dedicated PRBs config to UE via LPP.

In some examples, the UE 104a can receive PSCCH resource configuration including M dedicated PRBs related configuration (e.g., the value of M, the mapping between M dedicated PRBs and SL-PRS resource) from the BS 102 via RRC, MAC CE, or DCI. For example, the BS 102 can configure multiple PSCCH resources in a resource pool where each PSCCH resource includes M dedicated PRBs.

In some arrangements, the configuration designates that one common interlace or subchannel and a plurality of dedicated PRBs for transmitting the PSCCH. In some arrangements, the configuration includes a number of the plurality of dedicated PRBs. The configuration designates at least one of the plurality of dedicated PRBs are within a same RB set. The plurality of dedicated PRBs are within a same at least one interlace or subchannel. The plurality of dedicated PRBs includes one or more interlaces or subchannels.

In some arrangements, the configuration designates a mapping between the plurality of dedicated PRBs of the PSCCH and one or more resources for the SL-PRS, wherein the mapping includes at least a location and a number of the plurality of dedicated PRBs of the PSCCH, an occupied interlace index of the PSCCH, an occupied sub-channel index of the PSCCH, an RB set index of the PSCCH, a vector type of the PSCCH, a vector length of the PSCCH, or a vector index of the PSCCH, number of symbols for the PSCCH, starting symbol of the PSCCH, starting symbol of SL-PRS, number of symbols of SL-PRS, starting PRB of SL-PRS, comb size of SL-PRS, resource bandwidth of SL-PRS, SL-PRS resource ID.

Some arrangements relate to configuring one or more dedicated interlace/sub-channel(s) for transmitting the PSCCH. Interlace RB-based PSCCH transmission is configured or pre-configured where each PSCCH transmission for SL positioning occupies one or more dedicated interlace(s) or dedicated sub-channel(s). In some arrangements, the configuration in the method 400 designates that one or more dedicated interlaces or one or more dedicated sub-channels for transmitting the PSCCH.

In some arrangements, each PSCCH resource can be associated with a interlace index or a sub-channel index. A PSCCH resource can occupy one or multiple interlaces/sun-channels of one or multiple RB sets. In some arrangements, the configuration in the method 400 designates each resource for transmitting the PSCCH is mapped to one or more dedicated interlaces index or to one or more sub-channel index. This allows meeting of OCB and PSD requirement but can result in less PSCCH capacity. In 15 kHz, there are at most 5 interlaces, and in 30 kHz, there are at most 10 interlaces. The PSCCH capacity depends on the maximum number of interlaces or the maximum number sub-channels. In order to improve resource utilization and scheduling efficiency, increase PSCCH capacity and improve user experience, multi-UE multiplexing can be supported.

In some arrangements, a vector with a length and index can be configured to the UE 104a per PSCCH resource to allow multiple PSCCH resources multiplexed in the same interlace(s) to be orthogonal. The vector can either be a DFT vector or OCC vector. In the example in which the length of the vector is L, the PSCCH and/or the associated DMRS repeat Ls times. PRB level multiplexing represents that each L PRBs are a group and within the group the same PSCCH/SCI are repeatedly transmitted in each PRB (PSCCH/SCI transmitted in PRB 1 of the group is the same as that transmitted in PRB 2 of the group). the vector is intended on the PRB level. RE level multiplexing represents that each 1 REs are a group and within the group the same PSCCH/SCI are repeatedly transmitted in each RE (PSCCH/SCI transmitted in RE 1 of the group is the same as that transmitted in RE 2 of the group). The vector is intended on the RE level. In some arrangements, the configuration in the method 400 designates a length and an index of a vector for each of a plurality of UEs or for each resource for transmitting the PSCCH. Communicating the SL positioning-related transmission includes repeating by the first UE, at least one of the PSCCH or a DMRS corresponding to the PSCCH for a number of times equal to the length of the vector.

In some examples in which a DFT vector is configured or pre-configured to the UE 104a, PRB level or RE level cyclic shifts can be used for multi-PSCCH resources multiplexing. In some arrangements, the configuration in the method 400 designates a DFT vector for each of a plurality of wireless communication devices or for each resource for transmitting the PSCCH, wherein communicating the SL positioning-related transmission includes multiplexing multiple resources for transmitting the PSCCH using PRB-level cyclic shift or Resource Element (RE)-level cyclic shift. In some examples, the DFT vector length can be configured to L to enable at most L PSCCH resources multiplexed at the same time-frequency resources where each PSCCH resource multiplies a DFT vector and DFT vectors of multiplexed PSCCH resources are orthogonal. For example, if L=2, DFT vector 1 is [1, 1], DFT vector 2 can be [1, −1].

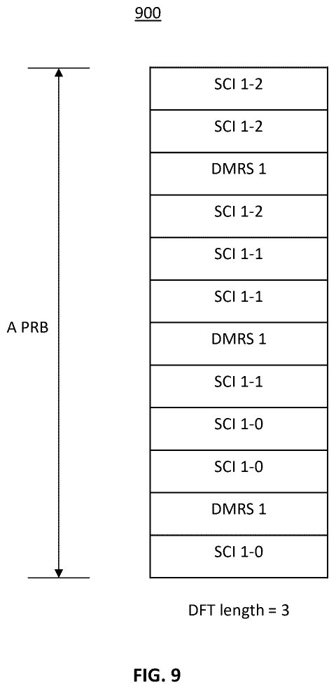

FIG. 9 is a diagram illustrating an example PRB 900 with an RE-level DFT vector for each PSCCH resource and associated DMRS, according to some arrangements. Each block represents an RE. In the example in which the length of a DFT vector is L (e.g., 3 in FIG. 9), the PSCCH and/or the associated DMRS is repeated L times. As shown in FIG. 9, the UE 104a intends to transmit {DMRS1, SCI 1-0, SCI 1-1, SCI 1-2}. The length of the DFT vector L=3 is configured to the UE 104a for this PSCCH resource, the UE 104a transmits the PSCCH and/or the DMRS 3 times, e.g., {DMRS1, DMRS1, DMRS1, SCI 1-0, SCI 1-0, SCI 1-0, SCI 1-1, SCI 1-1, SCI 1-1, SCI 1-2, SCI 1-2, SCI 1-2}. In the examples in which the current DMRS distribution in PSCCH is reused for SL-U positioning where DMRS is located in RE #1, RE #5 and RE #9, the length of the vector can be set as 3 as shown in FIG. 9.

In some examples, the vector can be used for FD-OCC. FD-OCC based multi-UE multiplexing can be supported and multiple UEs can use the same interlace(s). Each UE can be configured/provided with an OCC (orthogonal cover code) length and OCC index. In some examples, each PSCCH resource can be associated with an OCC length and OCC index. The OCC length can be configured as one of: 1, 2, 3, 4, 6. In the example in which OCC length is 4, at most 4 UEs are allowed to be multiplexed using the same interlace. In the example in which the length of an OCC vector is L, the PSCCH and/or the associated DMRS is repeated L times.

In some arrangements, the configuration in the method 400 designates that the vector is used for FD-OCC, and a plurality of UEs use a same interlace or a same subchannel. In some arrangements, the vector is used for TD-OCC, a plurality of UEs use a same interlace or a same subchannel. In some arrangements, the plurality of UEs includes the first UE (e.g., the UE 104a). In some arrangements, each of the plurality of wireless communication devices is configured with an OCC length and an OCC index. In some arrangements, each resource for transmitting the PSCCH is mapped to an OCC length or an OCC index.

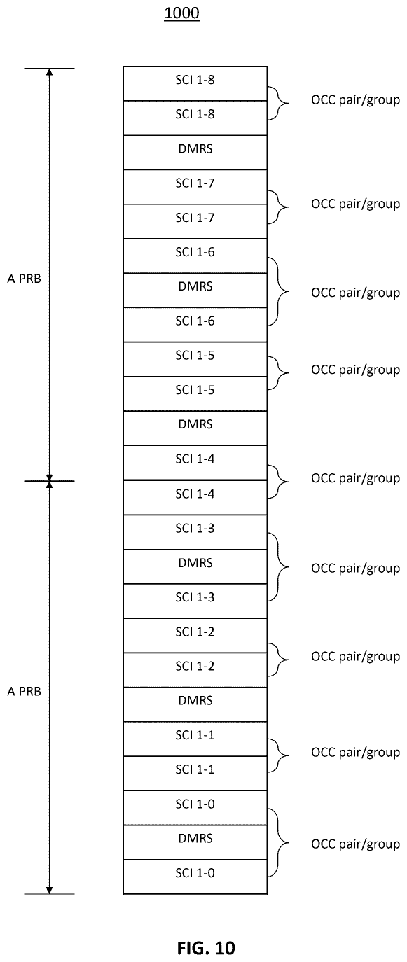

In some examples in which the current DMRS distribution in PSCCH is reused for SL-U positioning where DMRS is located in RE #1, RE #5 and RE #9, OCC length=2 cannot be supported within a single PRB given that there are 9 REs left in one PRB. In some examples, as long as the number of PRBs is even, RE-level FD-OCC within a PRB bundle can be supported. A PRB bundle includes even numbered PRBs (e.g. 2 PRBs). Suppose that the vector length is L, RE level FD-OCC represents that each L REs of a PRB bundle are a group, and within the group the same PSCCH/SCI are repeatedly transmitted in each RE. FIG. 10 is a diagram illustrating RE-level FD-OCC within a PRB bundle 1000 (e.g., 2 PRBs) for PSCCH in SL-U positioning, according to some arrangements. Each block represents an RE. As shown in FIG. 10, two REs from adjacent PRBs respectively can be seen as an OCC pair/group.

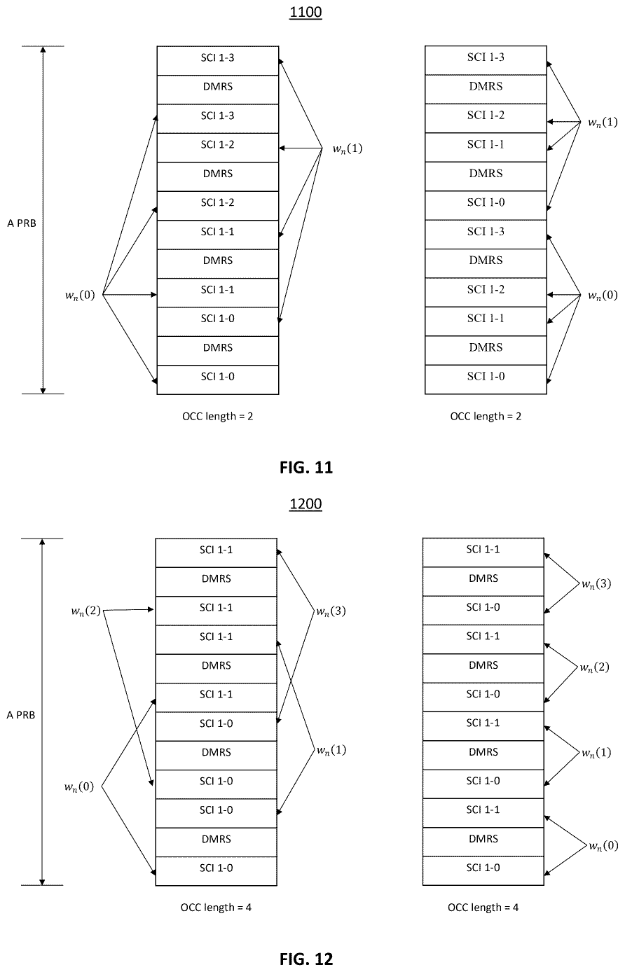

In some examples, RE-level FD-OCC can be supported. For RE-level FD-OCC, for the support of even numbered OCC length (e.g., OCC length=2, 4, 6, 8), the number of DMRS per PRB for PSCCH can be configured as an even number. e.g., the number of DMRS per PRB for PSCCH is 4 at {RE #1, RE #4, RE #7, RE #10} or {RE #0, RE #3, RE #6, RE #9}. FIG. 11 is a diagram illustrating RE-level FD-OCC for a PRB 1100 for PSCCH in SL-U positioning, according to some arrangements. Each block represents an RE. As shown in FIG. 11, the FD-OCC has an OCC length of 2. FIG. 12 is a diagram illustrating RE-level FD-OCC for a PRB 1200 for PSCCH in SL-U positioning, according to some arrangements. Each block represents an RE. As shown in FIG. 12, the FD-OCC has an OCC length of 4. The repetition mode can either be configured or pre-configured by another UE (e.g., the second UE or the third UE), the BS 102, the LMF, or determined by the first UE (e.g., the UE 104a) itself. In the example in which the OCC length is equal to 4 as shown in FIG. 12, either pattern {SCI 1-0, SCI 1-0, SCI 1-0, SCI 1-0, SCI 1-1, SCI 1-1, SCI 1-1, SCI 1-1} or {SCI 1-0, SCI 1-1, SCI 1-0, SCI 1-1, SCI 1-0, SCI 1-1, SCI 1-0, SCI 1-1} can be supported.

In some arrangements, RB-level FD-OCC can also be supported for PSCCH multiplexing for SL positioning.

In some arrangements, the first UE (e.g., the UE 104a) supports RE-level FD-OCC within a PRB bundle wherein a PRB bundle includes an even number of PRBs. The first UE supports RE-level FD-OCC, and the configuration designates a number of REs for DMRSs for each of the PRBs used to transmit the PSCCH is even. The first UE supports RB-level FD-OCC for multiplexing the PSCCH.

In some arrangements, TD-OCC based multi-UE multiplexing can be supported and multiple UEs can use the same interlace(s). Each UE can be configured/provided with an OCC (orthogonal cover code) length and OCC index. In some arrangements, each PSCCH resource can be associated with or mapped to an OCC length and OCC index for TD-OCC. In the example in which the number of symbols for PSCCH is L, and TD-OCC length is also L, each PSCCH and/or the associated DMRS is repeated by the UE 104a L times in each symbol of L symbols. The OCC length can be configured as one of 1, 2, or 3 depending on the number of symbols for PSCCH.

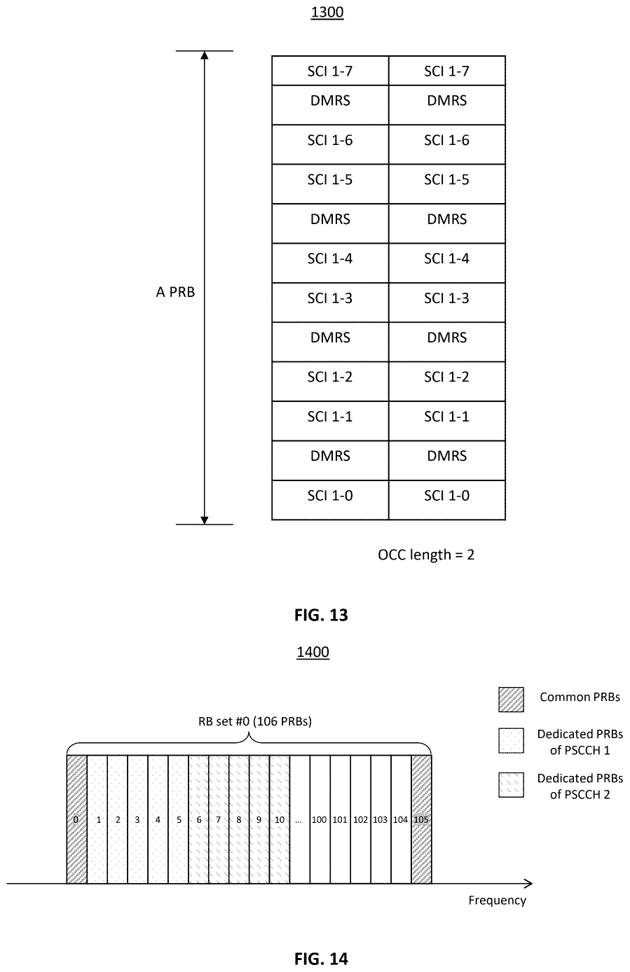

FIG. 13 is a diagram illustrating an PRB 1300 configured for TD-OCC for PSCCH in SL-U positioning, according to some arrangements. Each block represents an RE. In FIG. 13, the OCC length is 2. The time domain cyclic shifts or DFT can be used for multi-PSCCH resources multiplexing.

In some examples, the vector can be [1, 1] or [1, −1] for OCC length 2. In some examples, the vector can be [1, 1, 1, 1], [1, −1, 1, −1], [1, 1, −1, −1] or [1, −1, −1, 1] for OCC length 4. In some examples, for OCC length 4, the vector can be [1, 1, 1, 1], [1, −j, −1, j], [1, −1, 1, −1] or [1, j, −1, −j].

There are mapping between SCI's interlace index and one or more SL-PRS resource(s). The mapping can be configured or pre-configured by higher layers. For example, the mapping can be defined in each SL positioning resource pool. multiple “one PSCCH and associated one or more SL-PRS resources” pairs or multiple “one or more PSCCH and associated one SL-PRS resource” pairs can be configured or pre-configured. The mapping at least includes one of a starting symbol of SCI/PSCCH, number of symbols of SCI/PSCCH, starting PRB of SCI/PSCCH, PRB number of SCI/PSCCH, the location and number of dedicated PRBs, occupied interlace index (one or more), one or more occupied sub-channel index, one or more RB set index, vector type, vector length, vector index, OCC type (TD-OCC or FD-OCC), an OCC (orthogonal cover code) length, OCC index, starting symbol of associated SL-PRS, number of symbols of associated SL-PRS, starting PRB of associated SL-PRS, comb size of associated SL-PRS, resource bandwidth of associated SL-PRS.

In some examples, the UE 104a (e.g., the first UE) can receive PSCCH resource configuration including occupied interlace info and a vector config (e.g., OCC type, OCC length and OCC index, DET vector) from another UE (e.g., the second UE or the third UE) via SLPP. For example, a server UE can configure PSCCH multiplexing for multiple UEs with FD-OCC or TD-OCC.

In some examples, the UE 104a can receive PSCCH resource configuration (e.g., OCC type, OCC length and OCC index) from the LMF via LPP. For example, LMF can configure PSCCH multiplexing for multiple UEs with FD-OCC or TD-OCC. The LMF can send a request message via NRPPa to trigger BS(s) to provide the SL-PRS configurations and its associated PSCCH configuration including the mapping between PSCCH and SL-PRS. The BS 102 can send the PSCCH and SL-PRS configurations of different UEs to the LMF. In order to increase PSCCH capacity, the LMF can provide recommended PSCCH configuration including OCC config to the BS 102 via NRPPa. In this case, the UE 104a can receive OCC related configuration (e.g., OCC type, OCC length and OCC index) from the BS 102. In some examples, the LMF can provide PSCCH configuration including OCC config to UE via LPP. In some examples, the UE can receive PSCCH resource configuration (e.g., OCC type, OCC length and OCC index) from the BS 102a via RRC, MAC CE, or DCI. For example, the BS 102a can configure multiple PSCCH resources in a resource pool where each PSCCH resource is associated with OCC configuration.

In some arrangements, the configuration in the method 400 includes a mapping between one or more interlace index of PSCCH and one or more resources for transmitting the SL-PRS, wherein the mapping includes an OCC type, an OCC length, or an OCC index, one or more occupied interlace index of the PSCCH, one or more occupied sub-channel index of the PSCCH, one or more RB set index of the PSCCH, a vector type of the PSCCH, a vector length of the PSCCH, or a vector index of the PSCCH, number of symbols for the PSCCH, starting symbol of the PSCCH, starting symbol of SL-PRS, number of symbols of SL-PRS, starting PRB of SL-PRS, comb size of SL-PRS, resource bandwidth of SL-PRS, SL-PRS resource ID.

In some arrangements, the PSCCH is transmitted using dedicated PRBs and common PRBs. Interlace RB-based PSCCH transmission is configured or pre-configured where each PSCCH transmission for SL positioning occupies some dedicated PRBs and some common PRBs. The common PRBs is designed to satisfy OCB requirement.

FIG. 14 is a diagram illustrating an RB set (e.g., RB set #0) including 106 PRBs, according to some arrangements. In the FIG. 14, each PSCCH transmission for SL positioning occupies some dedicated PRBs and some common PRBs. As shown in FIG. 14, the common PRBs (e.g., PRB 0 and PRB 105) can be designed as the starting PRB and ending PRB of each RB set. There is a mapping relationship between SCI's K dedicated PRBs and one or more SL-PRS resource(s). The arrangements described herein relative to the dedicated PRB and the mapping between dedicated PRBs and SL-PRS are applicable. In some arrangements, the dedicated PRBs can be configured or pre-configured in the same RB set. In some arrangements, the dedicated PRBs can be configured or pre-configured on the same interlace or same interlaces. In some arrangements, the dedicated PRBs can occupy integer number of interlaces. In some arrangements, the dedicated ORBs can occupy only part of an interlace.

In some arrangements, the configuration in the method 400 designates that each PSCCH transmission occupies one or more dedicated PRBs or one or more common PRBs. the common PRBs as a starting PRB and an ending PRB of each RB set.

In some arrangements, the PSCCH is transmitted using partial interlace. Interlace RB-based PSCCH transmission is configured or pre-configured to the UE 104a where each PSCCH transmission for SL positioning occupies a partial-interlace/sub-interlace. In such case, multiple UEs can use the same interlace where each UE use part of one interlace.

In some examples, the partial interlace can be either RE-level partial interlace or RB level partial interlace. For PSCCH resource including RB level partial interlace, each PSCCH resource includes integer number of PRBs of one or more interlaces. Another PSCCH resource can include another integer number of PRBs of the same interlace(s).

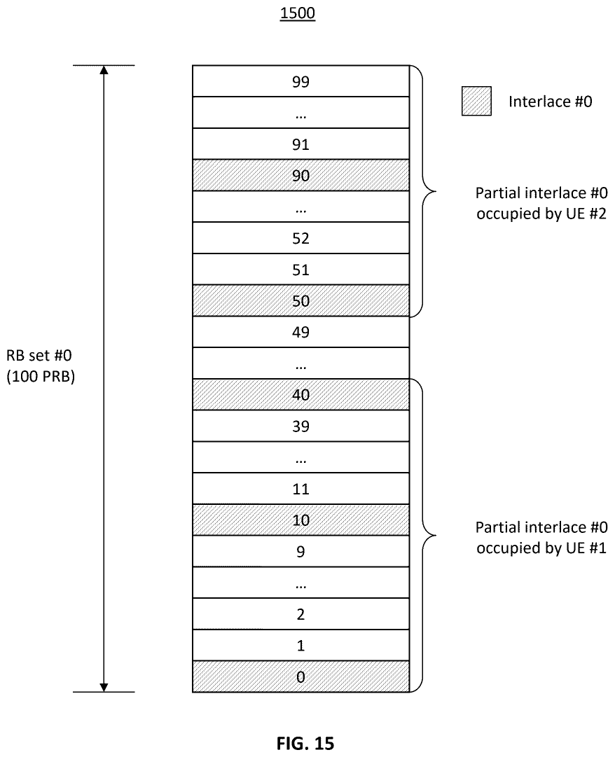

FIG. 15 is a diagram illustrating an RB set 1500 configured for PSCCH in SL-U positioning, according to some arrangements. The RB set 1500 includes 100 PRBs. Each PSCCH transmission for SL positioning occupies a partial-interlace/sub-interlace (RB level). As shown in FIG. 12, each interlace includes 10 PRBs. To meet OCB and PSD requirement, PSCCH transmitted by the UE 104a can occupy part PRBs of interlace #0 and another UE's PSCCH can occupy the other part PRBs of interlace #0.

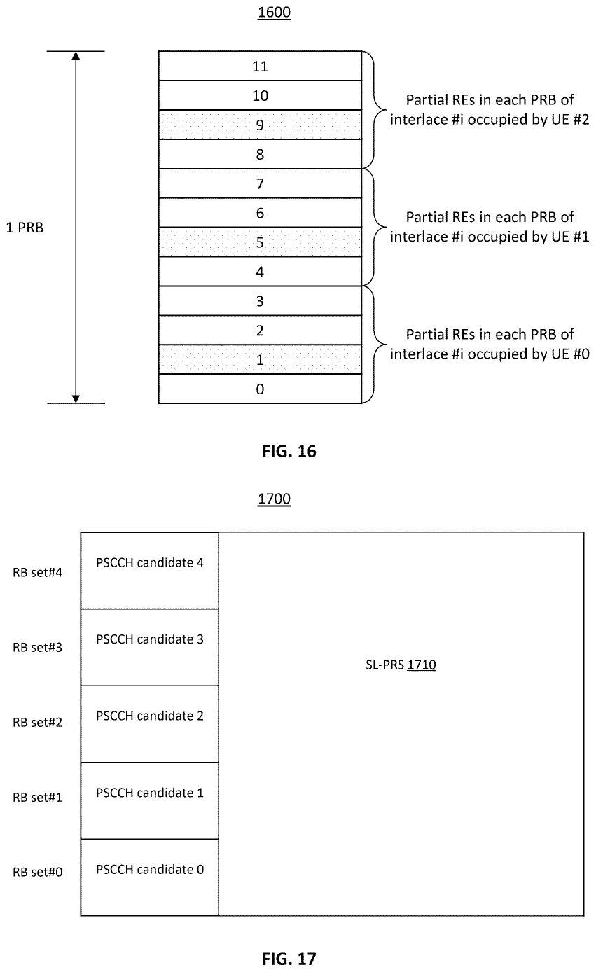

For PSCCH resource including RE level partial interlace, multiple PSCCH resources occupy the same all of the PRBs of one or more interlaces. Different PSCCH resources are FDMed in RE level. FIG. 16 is a diagram illustrating a PRB 1600 configured for PSCCH in SL-U positioning, according to some arrangements. The PRB 1600 includes 12 REs. Each PSCCH transmission for SL positioning occupies a partial-interlace/sub-interlace (RE level). As shown in FIG. 16, within one PRB 1600 of an interlace, PSCCH resources of three UEs (e.g., the UE #0, UE #1, and UE #2) are FDMed. Each UE occupies ⅓ of one RB resource.

In some arrangements, the configuration in the method 400 designates that each PSCCH transmission occupies a partial interlace or a sub-interlace for each of one or more interlaces. Each of a plurality of UEs use a part of same interlace, the plurality of UEs includes the first UE. In some arrangements, the configuration in the method 400 designates that the partial interlace is a RB-level partial interlace or a RE-level partial interlace.

In some arrangements, either FD-OCC, TD-OCC or both or a DFT vector can be applied. In some arrangements, in resource allocation scheme 1, BS or LMF can be responsible for PSCCH configuration. The UE 104a can receive PSCCH resource configuration including partial interlace configuration from the BS 102 via RRC, MAC CE, or DCI. For example, the BS 102 can configure multiple PSCCH resources in a resource pool where each PSCCH resource occupies partial interlace. The UE 104a can receive PSCCH resource configuration including partial interlace from the LMF via LPP. For example, the LMF can configure multiple UEs' PSCCH resources. In some arrangements, the LMF can send a request message via NRPPa to trigger BS(s) to provide the SL-PRS configurations and its associated PSCCH configuration including the mapping between PSCCH and SL-PRS. The BS 102 can send the PSCCH and SL-PRS configurations of different UEs to the LMF. In order to increase PSCCH capacity, the LMF can provide recommended PSCCH configuration including partial interlace configuration to the BS 102 via NRPPa. In this case, UE can receive PSCCH related configuration from the BS 102. In some examples, the LMF can provide PSCCH configuration including partial interlace configuration to the UE 104a via LPP.

In resource allocation scheme 2, the server UE (e.g., a third UE) can be responsible for PSCCH configuration. The UE 104a can receive PSCCH resource configuration including partial interlace configuration from another UE (the third UE) via SLPP. For example, the server UE can configure multiple UEs' PSCCH multiplexing via RB level or RE-level partial interlace.

In some arrangements, the configuration of the PSCCH includes partial interlace configuration is received by the first UE (e.g., the UE 104a) from the BS 102 via at least one of RRC signaling, a DCI, a MAC CE, or a SIB. In some arrangements, the configuration of the PSCCH including the partial interlace configuration is received by the UE from a LMF via LPP. In some arrangements, the configuration of the PSCCH including the partial interlace configuration is received by the first UE from a third UE via at least one of SLPP, PC5-RRC signaling, SL MAC CE, or SCI.

The SCI's interlace index is mapped to the frequency range one or more SL-PRS resource(s). The mapping relationship can be configured or pre-configured by higher layers. For example, the mapping can be defined in each SL positioning resource pool. Multiple “one PSCCH and associated one or more SL-PRS resources” pairs or multiple “one or more PSCCH and associated one SL-PRS resource” pairs can be configured or pre-configured. The mapping at least includes one of interlace multiplexing type (RE-level partial interlace or RB-level partial interlace), RE index if RE level partial interlace is enabled, PRB index, starting symbol of SCI/PSCCH, number of symbols of SCI/PSCCH, starting PRB of SCI/PSCCH, PRB number of SCI/PSCCH, the location and number of dedicated PRBs, occupied interlace index (one or more), one or more occupied sub-channel index, one or more RB set index, vector type, vector length, vector index, OCC type (TD-OCC or FD-OCC), an OCC (orthogonal cover code) length, OCC index, starting symbol of associated SL-PRS, number of symbols of associated SL-PRS, starting PRB of associated SL-PRS, comb size of associated SL-PRS, resource bandwidth of associated SL-PRS.

In some arrangements, the configuration in the method 400 includes a mapping between the resource for transmitting the PSCCH and one or more resources for transmitting the SL-PRS. The mapping includes a partial interlace multiplexing type of the PSCCH, an RE index or RE range within a PRB of the PSCCH, or a PRB index of the PSCCH, one or more occupied interlace index of the PSCCH, one or more occupied sub-channel index of the PSCCH, one or more RB set index of the PSCCH, number of symbols for the PSCCH, starting symbol of the PSCCH, starting symbol of SL-PRS, number of symbols of SL-PRS, starting PRB of SL-PRS, comb size of SL-PRS, resource bandwidth of SL-PRS, or SL-PRS resource ID.

In some arrangements, the PSCCH can be transmitted by the UE 104a μsing multiple channels (e.g., in a multi-channel scenario). In a multi-channel scenarios, interlace RB-based PSCCH transmission is configured or pre-configured where the number of RB sets occupied by PSCCH and that occupied by its associated SL-PRS can be the same or different. Different PSCCH resources can be in different RB set. In other words, PSCCH resources can be configured according to FDM in the granularity of RB set. FIG. 17 is a diagram illustrating RB sets that are resources used to transmit PSCCH and SL-PRS 1710, according to some arrangements. In some examples, the SL-PRS 1710 can occupy all the RB sets #0-#4 as resource pool in dedicated resource pool. The PSCCH (e.g., PSCCH candidates 0-4) can occupy only one or some of the RB set(s). Within one RB set, different PSCCH resources can still be transmitted in an interlaced manner. FIG. 17 illustrates that the number of RB sets occupied by PSCCH and that occupied by its associated SL-PRS 1710 can be different.

In the example in which the number of RB sets occupied by PSCCH and the number of RB sets occupied by associated SL-PRS are the same, in response to the PSCCH successfully accessing all RB sets, the corresponding SL-PRS need to perform only Type 2 channel access or not perform channel access at all before SL-PRS transmission. Therefore, such arrangements can improve the SL-PRS LBT success probability. PSCCH resources occupying same RB set(s) can use interlace RB-based transmission.

In some arrangements, a number of RB sets occupied by the PSCCH and a number RB sets occupied by the SL-PRS are same or different. Resources for transmitting the PSCCH are in two or more different RB sets. The resources for transmitting the PSCCH are FDMed in a granularity of the RB set.

Some arrangements relate to transmitting PSCCH using continuous RB-based transmission. Contiguous RB-based PSCCH transmission is configured or pre-configured to the UE 104a where each PSCCH resource includes contiguous RBs. In some arrangements, in the method 400, the configuration designates each resource for transmitting the PSCCH comprises continuous RBs. There is no need to introduce interlace RB-based PSCCH transmission. One PSCCH resource is expected to occupy at least one channel. FDM-based PSCCH resources can be supported in some examples. In some examples, TDM-based PSCCH resources can be supported.

In some examples, the bandwidth of PSCCH is different from the associated SL-PRS from one Tx UE's perspective. In some examples, the bandwidth of PSCCH is the same as the associated SL-PRS from one Tx UE's perspective. A vector with its length and index can be configured to the UE 104a per PSCCH resource so that multiple PSCCH resources are orthogonal. The vector can either be a DFT vector or OCC vector. In the example in which the length of the vector is L, the PSCCH and/or the associated DMRS is repeated by the UE 104a L times.

In some examples, the UE 104a can receive PSCCH resource configuration including contiguous RBs from another UE (e.g., the third UE) via SLPP. In some examples, the UE 104a can receive PSCCH resource configuration including contiguous RBs from BS via RRC, DCI, or MAC CE, for example, via RRC signaling. Each PSCCH is configured or pre-configured in a resource pool. In some examples, the UE 104a can receive PSCCH resource configuration including contiguous RBs from the BS 102 via LPP.

There can be a mapping relationship between a PSSCH resource and one or more SL-PRS resources as described herein.

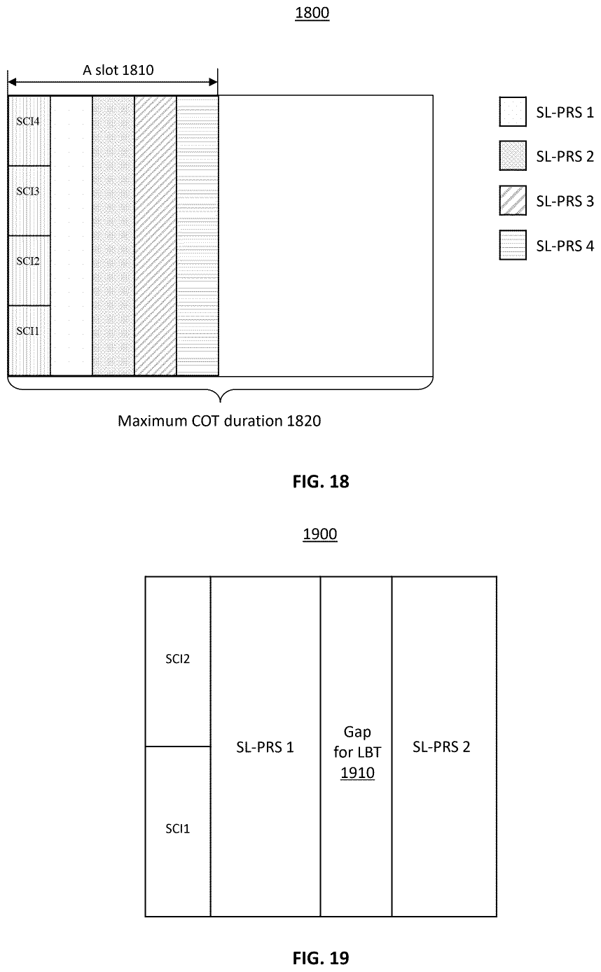

Some arrangements relate to time-domain resource (e.g., slot structure) for SL-U positioning. Some arrangements relate to TDM-based multiplexing of a SL-PRS from different UEs in a slot for dedicated resource pools. FIG. 18 is a diagram illustrating TDM-based multiplexing 1800 of SL-PRS from different UEs in a slot 1810, according to some arrangements. The maximum COT duration 1820 can be used by different UEs. In dedicated resource pools, TDM-based multiplexing of SL-PRS from different UEs in a slot 1810 are supported for larger capacity. From one Tx UE's perspective, a UE can select or be configured/scheduled with one of {SL-PRS resource 1, SL-PRS resource 2, SL-PRS resource 3, SL-PRS resource 4} as shown in FIG. 18. If SL-PRS resource 1 is selected, configured, or scheduled where the time offset between PSCCH/SCI and SL-PRS resource 1 is 0, the UE needs to perform channel access only once before SCI/PSCCH transmission. If the time offset between PSCCH/SCI and SL-PRS resource is not 0 (e.g., SL-PRS resource 2, 3, 4 shown in FIG. 18), the UE needs to perform channel access twice before SCI/PSCCH transmission.

In the example in which the PSCCH not adjacent with the associated SL-PRS resource(s), PSCCH symbol(s) are mapped from the second symbol available for SL transmission in a slot.

In some examples, an idle period/gap is introduced between two adjacent TDMed SL-PRS resources. The AGC symbol location, TDMed SL-PRS resources, or the idle period/gap in a slot can be configured or pre-configured at the BWP level considering Rx UE. For TDM-based multiplexing of SL PRS resources in a slot, the starting symbol of each TDMed SL PRS resource and the idle period/gap between two adjacent TDMed SL-PRS resources can be configured at the BWP level. In other words, as long as UEs transmit SL PRS on the same BWP, idle period/gap for SL PRS resources that may be TDM-ed within a slot are aligned across UEs. FIG. 19 is a diagram illustrating resources 1900 for transmitting SL-PRS with a gap 1910 introduced between two adjacent SL-PRS resources 1 and 2, according to some arrangements. The SL-PRS resource 1 is used by one UE to transmit SL-PRS, and SL-PRS resource 2 is used by a different UE to transmit another SL-PRS. If there is no gap between two adjacent resources (e.g., symbols), the UE 104a which intends to transmit using SL-PRS resource 2 will fail to access the channel given that the channel condition is busy for transmission on SL-PRS resource 1.

In some arrangements, the idle period/gap can be defined as N symbol(s). N can be 1, or the length of idle period/gap can be associated with SCS value and/or channel access type. The idle period/gap can be configured to the UE 104a per SL-PRS resource. The idle period/gap can be configured at the BWP level, in some examples. In some examples, the idle period/gap can be configured at the carrier level. In some examples, the idle period/gap configuration can be aligned (e.g., the same) across carriers if carrier aggregation is enabled/configured. The configuration of idle period/gap includes the time domain length, the starting symbol of a slot, number of idle period/gap within a slot. For example, a SL-PRS resource is immediately followed by an idle period or gap. The SL-PRS resource configuration including the idle period/gap can be provided to the UE 104a from the BS 102 via RRC, MAC CE, or DCI, in some examples. In some examples, the SL-PRS resource configuration including the idle period/gap can be provided to the UE 104a from LMF via LPP. In some examples, the SL-PRS resource configuration including the idle period/gap can be provided to the UE 104a from another UE (e.g., a third UE) via SLPP, SL MAC CE, or SCI.

In some arrangements, the configuration in the method 400 includes a first idle period between two adjacent resources for transmitting the SL-PRS. Each of two UEs transmits one of the two adjacent resources, the two UEs includes the first UE. In some examples, the configuration in the method 400 includes a second idle period between two adjacent resources for transmitting the SL-PRS and PSCCH. Each SL-PRS is immediately preceded by a resource for PSCCH. The first or the second idle period is defined by at least one time-domain resource. A length of the at least one time-domain resource is mapped to at least one of a SCS value or a channel access type. In some examples, the configuration in the method 400 includes the first or the second idle period defined in each slot at the BWP level or at the carrier level or cross carriers. In some examples, the configuration in the method 400 includes the first or the second idle period for each resource for transmitting the SL-PRS. In some examples, the configuration in the method 400 includes the first or the second idle period is received by the first wireless communication device from a BS via at least one of RRC signaling, a DCI, or a MAC CE. In some examples, the configuration in the method 400 includes the first or the second idle period is received by the first wireless communication device from an LMF via LPP. In some examples, the configuration in the method 400 includes the first or the second idle period is received by the first UE from a third UE via at least one of SLPP, SL MAC CE, or SCI.

In some examples, SL-PRS resources with potential LBT failure problem can be excluded for TDM-based multiplexing of SL-PRS from different UEs in a slot. In the example in which there are N available TDM-ed SL-PRS resources in a slot, based on configuration or pre-configuration, the UE 104a does not select a SL-PRS resource which is adjacent with another UE's SL-PRS resource in resource allocation scheme 2. In some examples, another UE (e.g., the third UE) recommends, does not recommend (e.g., recommend against), or configure the SL-PRS resource for the UE 104a via SLPP, SCI, or SL MAC CE.

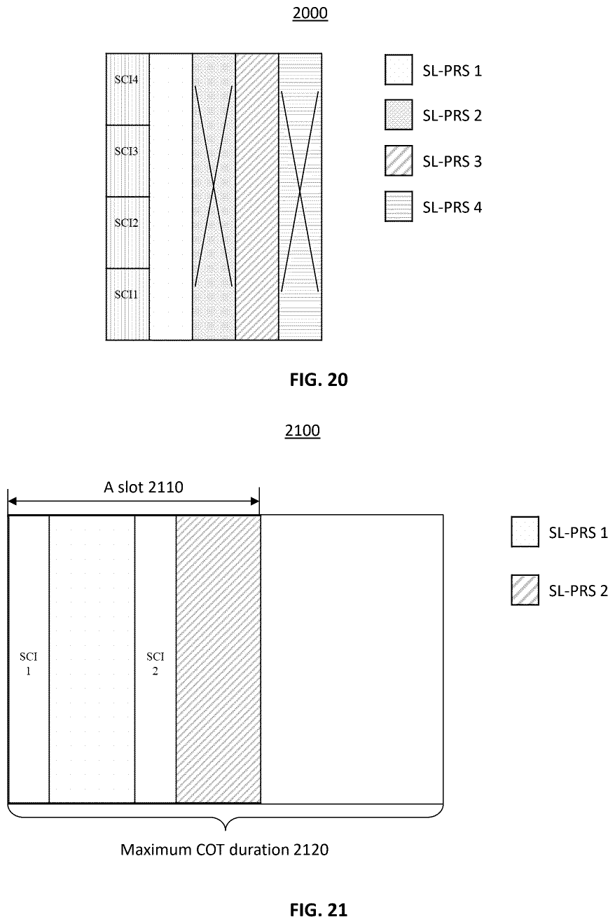

FIG. 20 is a diagram illustrating example resources 2000 in which one or more TDMed SL-PRS resources are disabled to avoid potential LBT failure, according to some arrangements. In resource allocation scheme 1, network (e.g., BS via RRC, DCI, MAC CE, LMF via LPP) can configure or schedule the SL-PRS resource(s) without potential conflict. As shown in FIG. 20, the network can disable the use of SL-PRS resource 2 and SL-PRS resource 4 due to potential conflict. The UE 104a does not transmit any SL-PRS using SL-PRS resource 2 and SL-PRS resource 4.

In some arrangements, the method 400 further includes excluding, by the first UE, at least one resource for transmitting the SL-PRS based on LBT failure. The SL-PRS is TDMed for different UEs in a time-domain resource. In some arrangements, the method 400 further includes receiving, by the first UE from a third UE via at least one of SLPP, a MAC CE, or SCI, configuration of the at least one resource for transmitting the SL-PRS. In some arrangements, the method 400 further includes receiving, by the first UE from a BS via at least one of RRC signaling, a DCI, or a MAC CE or from an LMF via LPP, configuration of the at least one resource for transmitting the SL-PRS without conflicting with other UEs of the different UEs.

In some arrangements in which the gap is not configured per SL-PRS resource, for a UE, multiple candidate SL-PRS resources, repetitions, occasions, or COTs can be configured within a slot. In such case, increasing LBT success probability is enabled by designing multiple chances for a SL-PRS. In some arrangements, the configuration includes at least one of a plurality of resources for transmitting the SL-PRS, a plurality of repetitions for transmitting the SL-PRS, a plurality of occasions for transmitting the SL-PRS, or a plurality of COTs for transmitting the SL-PRS within a time-domain resource (e.g., a slot).

In some examples, in order to assure that a UE need to perform CCA only once for both SCI and associated SL-PRS transmission, a sub-slot structure can be applied as shown in FIG. 21. FIG. 21 is a diagram illustrating example resources 2100 including a slot 2120 in which multiple SL-PRS resources 1 and 2 are configured, according to some arrangements.

In some examples in which UE1 transmits SCI1 and associated SL-PRS using SL-PRS resource 1, it is highly possible that UE2 cannot access the channel to transmit SCI 2 and associated SL-PRS using SL-PRS resource 2.

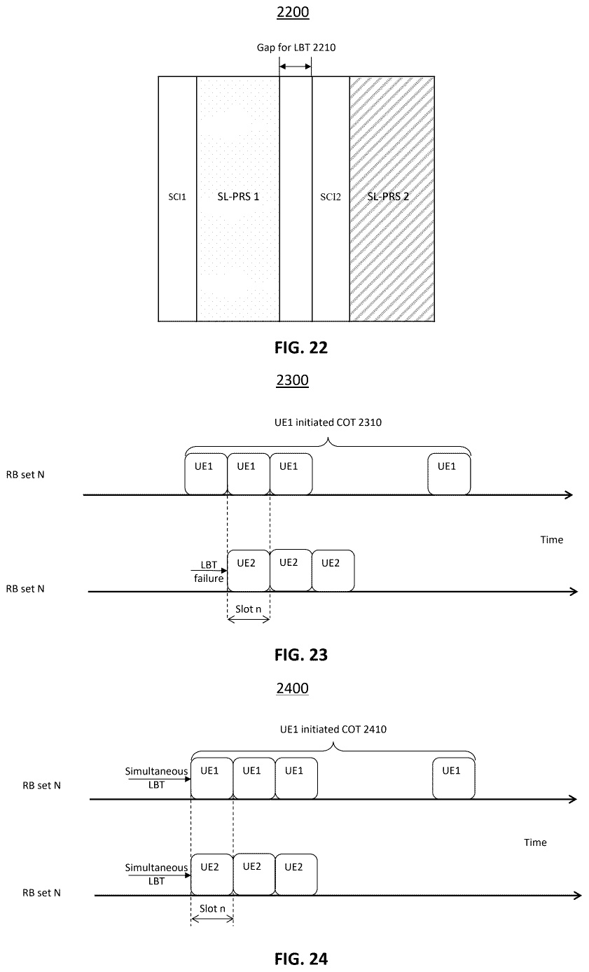

In some examples, an idle period/gap is introduced between two adjacent “SCI+SL-PRS” resources for sub-slot structure. FIG. 22 is a diagram illustrating example time-domain resource 2200 (e.g., a slot) with a gap 2210 for LBT between two SCI+SL-PRS resources for two respective UEs, according to some arrangements. As shown in FIG. 22, a gap 2210 for LBT is introduced between SL-PRS resource 1 and SCI 2. If there is no gap between two adjacent symbols, the UE 104a which intends to transmit SCI 2 and SL-PRS resource 2 fails to access the channel cause the channel condition is at least busy for SL-PRS resource 1's transmission.

The idle period/gap can be defined as N symbol(s). N can be 1, or the length of idle period/gap can be associated with SCS value and/or channel access type. The idle period/gap can be configured per SL-PRS resource. For example, a SL-PRS resource is immediately followed by an idle period or gap. In some examples, the SL-PRS resource configuration including the idle period/gap can be provided to the UE 104a from the BS 102 via RRC, MAC CE, or DCI. In some examples, the SL-PRS resource configuration including the idle period/gap can be provided to the UE 104a from LMF via LPP. In some examples, the SL-PRS resource configuration including the idle period/gap can be provided to the UE 104a from another UE (e.g., the third UE) via SLPP, SL MAC CE, or SCI.

In some arrangements, SL-PRS resources with potential LBT failure problem are excluded. In the example in which there are N available TDM-ed SL-PRS resources in a slot, depending on configuration or pre-configuration, a UE 104a does not select a SL-PRS resource which is adjacent with another UE's SL-PRS resource in resource allocation scheme 2. In some examples, another UE (e.g., a third UE) recommend, does not recommend (e.g., recommend against), or configure the SL-PRS resource for the UE 104a via SLPP, SCI, SL MAC CE.

In resource allocation scheme 1, the network (e.g., the BS 102 via RRC, DCI, or MAC CE, LMF via LPP) configures or schedules the SL-PRS resource(s) without potential conflict. As shown in FIG. 22, the network can disable the use of SL-PRS resource 2 and SL-PRS resource 4. If the gap is not configured per SL-PRS resource, for a UE candidate SL-PRS resource, repetition, occasion, or COT can be configured within a time-domain resource (e.g., a slot). In such case, increasing LBT success probability is enabled by designing multiple chances for a SL-PRS.

Some arrangements relate to LBT bock and multi-UE multiplexing. For SL positioning in dedicated resource pool, both comb-based multiplexing and TDM-based multiplexing of SL-PRS from different UEs in a slot are supported. In SL-U positioning, two UEs that intended to use the same or adjacent resource(s) to transmit SL-PRS. FIG. 23 is a diagram illustrating an LBT failure 2300 of one UE (e.g., UE1) caused by another UE's (e.g., UE2's) SL-PRS and/or PSCCH transmission, according to some arrangements. As shown in FIG. 23, both UE1 and UE2 are to transmit SL-PRS in slot n of RB set N. UE1 can transmit various transmissions within the COT 2310 initiated by UE1. UE2 can fail in its Type 1 channel access due to UE1 accessing the channel earlier than UE2 and transmitting in slot n−1. Moreover, given the situation that TDM-based multiplexing of SL-PRS from different UEs in a slot are supported, in some examples, SCI and its associated SL-PRS resources are not adjacent to each other. For SL-U positioning, not only slot-level LBT block can occur, but also symbol-level LBT block can occur. The arrangements described herein can be applied to both slot-level LBT block issue and symbol-level LBT block issue.

Some arrangements relate to address such LBT block issue to allow different UEs selecting SL-PRS resources without affecting each other and to improve the probability of channel access success.

FIG. 24 is a diagram illustrating an example configuration 2400 of time-domain resources of UEs for transmitting SL-PRS and/or PSCCH transmissions, according to some arrangements. The SL-PRS of UE1 and UE2 are multiplexed in a same slot access the channel simultaneously. In some arrangements, the UEs multiplexed (including either TDM-based multiplexing, comb-based multiplexing, or both) in the same time-domain resource (e.g., slot) can access the channel simultaneously as shown in FIG. 24. UE1 can transmit various transmissions within the COT 2410 initiated by UE1. Both UE1 and UE2 are to transmit SL-PRS in a slot n of RB set N.

At least for resource allocation scheme 2 of SL positioning, UEs (for example UEs in the same positioning session) can report their sensing results including a set of candidate SL-PRS resources to a server UE (e.g., a third UE) via SLPP, SCI, SL MAC CE. Then, the server UE can determine which slot resources (e.g., slot n) is shared and to be multiplexed-used by more than one UEs. By default, those UEs sharing the same slot n shall begin LBT procedure at the same time (e.g., slot n-T) if those UEs have the same priority/CAPC. In the examples in which those UEs have different SL-PRS priority/CAPC, the LBT beginning time of them are different.

In some examples, the server UE can request UE(s) to report sensing results within a window via SLPP, SCI, SL MAC CE, the window is configured or pre-configured. A server UE can indicate the beginning time of an LBT procedure to the UE (e.g., the UE 104a) via SLPP, SL MAC CE, or SCI. In some examples, considering resource allocation scheme 1 of SL positioning, the serving BS 102 or LMF can indicate the beginning time of an LBT procedure to the UE (e.g., the UE 104a). For LMF's involvement, the BS 102 or the UE 104a can report the SL-PRS priority and/or CAPC and the time-frequency domain location (e.g., RB set index(s)) of SL-PRS to LMF via NRPPa and LPP respectively. The LMF indicates/configures an appropriate LBT beginning time for the BS 102 or the UE 104a based on CAPC value via NRPPa and LPP respectively. The BS 102 can indicate the recommended LBT beginning time for a scheduled or configured SL transmission (dynamic grant or configure grant). This can be carried by either RRC or DCI (e.g. DCI 2-0, DCI 3-0, or a DCI dedicated for SL positioning). The UE 104a can request the BS 102 via UCI, RRC, or MAC CE or the LMF via LPP for appropriate LBT timing or request for CAPC value.

In some arrangements, the method 400 further includes receiving, by the first UE from a third UE via at least one of SLPP, SL MAC CE, or SCI, an indication of a beginning time of a LBT procedure. In some arrangements, the method 400 further includes receiving, by the first UE from a BS via at least one of RRC signaling, a DCI, or a MAC CE or from an LMF via LPP, the indication of the beginning time of the LBT procedure.

In some arrangements, from resource allocation perspective, different UEs' transmission occasions at the same time (e.g., begin at the same symbol or begin at the same slot) are guaranteed. In some examples, a UE (e.g., server UE) can coordinate or configure SL-PRS resources or SL-PRS transmission occasions of UEs via SLPP to guarantee transmission occasions of different UEs are at the same time. This information can be included as part of assistance data. In some examples, an LMF can coordinate or configure SL-PRS resources or SL-PRS transmission occasions of UEs via LPP to guarantee transmission occasions of different UEs are at the same time. In some examples, a BS can configure SL-PRS resources or SL-PRS transmission occasions of different UEs via RRC, MAC CE, or DCI to guarantee transmission occasions of different UEs are at the same time.

In some arrangements, a SL positioning-related transmission occasion of a plurality of wireless communication devices begins at a same time according to the configuration of a third wireless communication device or a BS or an LMF.

In some arrangements, the probability of LBT success can be improved by COT sharing. In some examples, COT sharing requires that there are “source and/or destination pair” relationships between initiating UE and responding UE (sometimes referred to as dedicated COT sharing). In some examples, a time window can be configured or pre-configured where a common COT is allowed in that window. In some examples, the time window can be configured or pre-configured to only allow a dedicated COT sharing such that time-domain resources outside the window common COT sharing is allowed.

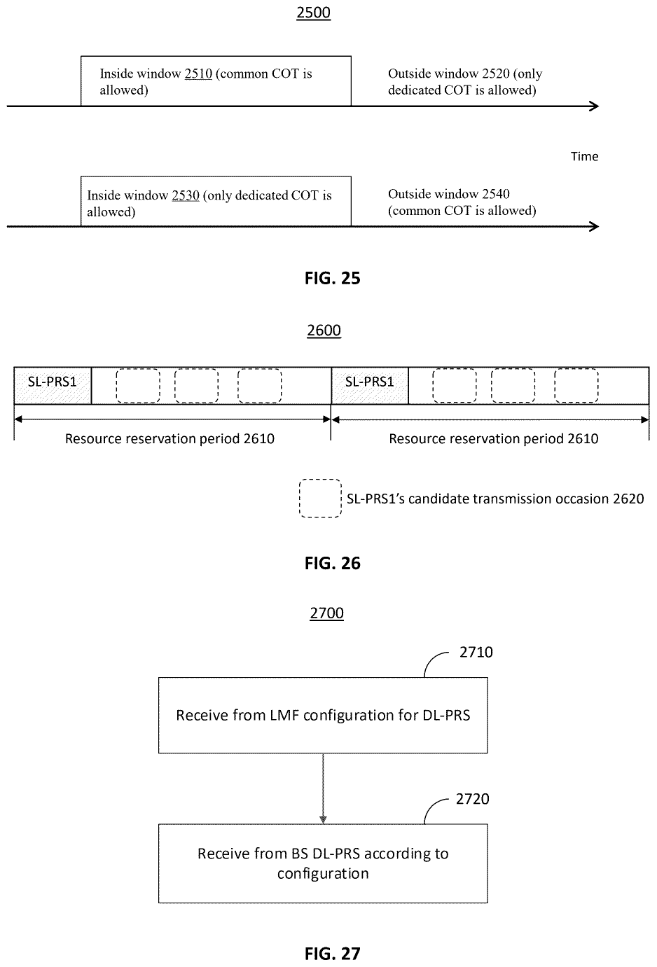

FIG. 25 is a diagram illustrating a configuration 2500 including an example time window for transmitting a SL positioning-related transmission by a plurality of UEs, according to some arrangements. In some examples, the time window can be configured or pre-configured where common COT is allowed in that window 2510, and time-domain resources outside of the window 2520 can be used only for the dedicated COT. In some examples, the time window can be configured or pre-configured where only dedicated COT is allowed in that window 2530, and time-domain resources outside of the window 2540 can be used for common COT.

Allowing common COT sharing can improve the probability of LBT success, to allow other UEs to freely access this COT with fixed CCA time and their transmissions are not necessarily intended for COT initiating UE.

In some arrangements, an LMF or server UE (e.g., the third UE) can configure such a window applicable for multiple UEs (e.g., all UEs or UEs involved in a positioning session), the signaling can be LPP, SLPP, SCI, SL MAC CE. In some examples, the BS 102 can configure such a window to the UE 104a via DCI, MAC CE or RRC. In some examples, a common time window can be defined or set using pre-configuration. In some examples, the configuration parameters of the time window can include one or more of the time span of window, periodicity, starting time (e.g., timing offset), index of window, and so on.

In some examples, the method 400 further includes receiving, by the first UE, a time window in which a common COT is configured or a dedicated COT is configured, and a common COT is configured outside of the time window. In some examples, the configuration of the time window is received by the first UE from one of an LMF via LPP, a third UE via at least one of SLPP, MAC CE, or SCI, or a BS via at least one of RRC signaling, a DCI, or a MAC CE. The configuration of the time window is used by a plurality of UEs. The configuration of the time window includes at least one of a time span of the time window, periodicity of the time window, a starting time of the time window, timing offset of the time window, or an index of the time window.

In some examples, a UE 104a can request for this window. For example, the UE can indicate the time/frequency location of its candidate transmission resources, or the UE can explicitly request for a window with a window index if multiple windows are configured or pre-configured. The UE 104a can request the window using requesting signaling such as DCI, MAC CE, LPP, SLPP, SCI, SL MAC CE, and so on.

By providing common COT sharing inside a window, a UE can easily access a COT within a window and transmit its SL-PRS. This type of window can be intended for high-priority positioning service.

In some arrangements, in the LBT procedure, instead of detecting energy of a channel bandwidth considering all transmissions, energy detection of LBT/CCA procedure exclude the SL-PRS transmission of other UE. This is due to the presence of the sensing before transmission mechanism in SL-PRS resource allocation scheme 2, and in resource allocation scheme 1, the network can schedule to make sure SL-PRS transmissions of different UEs do not conflict or collide. Therefore, LBT can consider another radio access technology's transmission (e.g., transmission by Wi-Fi devices) other than SL-PRS transmission.

In some arrangements, the method 400 further includes excluding, by the first UE, energy of SL-PRS transmission of another UE in an energy detection of an LBT procedure or a CCA procedure.

In some arrangements, additional transmission occasions can be added for SL positioning. More SL-PRS transmission occasions can be configured or pre-configured or selected to accommodate potential LBT failure.

In some arrangements, for each SL-PRS resource (e.g., having some characteristics associated: SL-PRS comb offset, comb size, starting symbol, number of symbols within a slot, frequency domain allocation or bandwidth, SL-PRS resource ID, and so on), two or more transmission occasions can be configured, pre-configured, or selected. For example, for SL positioning in licensed band, only one slot (e.g., slot n) that is within a periodicity for a periodic SL-PRS is assigned for a SL-PRS resource. Then for SL positioning in unlicensed band, N slots (within a periodicity for a periodic SL-PRS) is assigned for a SL-PRS resource. This SL-PRS resource can be selected, configured, or pre-configured in slot n, slot n+1, slot n+2.

In some arrangements, each SL-PRS resource is configured with one repetition factor. The UE 104a can receive this configuration in RRC signaling from the BS 102 in some examples. In some examples, the LMF or server UE can indicate to the UE 104a to repeatedly transmission a SL-PRS resource via LPP or SLPP/SL MAC CE/SCI signaling respectively. For retransmissions for each SL-PRS resource, a maximum retransmission time is configured or pre-configured by the BS 102 or by the UE 104a or by LMF. The maximum retransmission time can be either configured or pre-configured/selected per resource pool, per SL-PRS resource, per SL-PRS resource set or per UE. In resource allocation scheme 1, the BS 102 schedules or configures that one SL-PRS is associated with multiple transmission occasions. In resource allocation scheme 2, in selection window, the candidate resources selected in resource selection window is adequate for potential LBT failure. In one example, a larger potion (similar as sl-TxPercentageList) of candidate SL-PRS resource over the total resources can be applied, for example, the potion can be configured or pre-configured as for example, 20%, 35%, 50%, or 75% in each resource pool.

Some arrangements relate to the UE 104a treating different candidate resource(s) in a selection window. For example, different candidate SL-PRS transmission occasions or time-domain resource in a selection window can be associated with different priorities. For example, a candidate SL-PRS resource can be set as lower priority if the candidate SL-PRS resource suffers from potential LBT failure. In some examples, in resource allocation scheme 2, the UE 104a will report a set of candidate resources for SL-PRS transmission to its higher layer based on sensing results. To accommodate potential LBT failure, the set of candidate resources for SL-PRS transmission is determined based on both the sensing results and the LBT block situation.

In some arrangements, the method 400 further includes determining, by the first UE, resources for transmitting the SL-PRS within a selection window, determining, by the first UE, LBT failure on a first resource of the resources or a first resource of the resources blocks a high-priority SL-PRS resource reserved by another UE, and determining, by the first UE, that the first resource of the resources has a first priority lower than a second priority of a second resource without the LBT failure.

In some examples in which the set of candidate resources for SL-PRS transmission based on sensing results is SA, before the UE 104a reporting to a higher layer, the UE 104a excludes at least one of: (1) one or more resources (if more than one resource, consecutive resources) after a reserved SL-PRS resource when the LBT time of those one or more selected resources overlap with the transmission duration of the reserved SL-PRS resource; (2) one or more resources (if more than one resource, consecutive resources) before a high-priority reserved SL-PRS resource, high-priority means either the transmission priority of SL-PRS is high (value is small) or the CAPC of this reserved SL-PRS transmission is low. The set of candidate resources for SL-PRS transmission based on both sensing results and LBT block situation is SB. Defining whether reserved SL-PRS transmission is high-priority can be based on comparing the reserved SL-PRS transmission with that of the selected candidate resource(s). Defining whether the reserved SL-PRS transmission is high-priority can also be based on comparing it with a threshold. The threshold can be configured or pre-configured per resource pool. In some examples, a candidate resource which not only conflicts with another SL transmission based on sensing results but also lacks LBT block is deemed as a high-priority-candidate. Otherwise, the candidate resource is deemed as a low-priority-candidate.

In some arrangements, to accommodate potential LBT failure, the set of candidate resources for SL-PRS transmission is determined based on the sensing results, COT sharing condition, and the LBT block situation. There is no need for UE to exclude a following resources if that resource can either share a COT of the reserved SL-PRS resource by another UE (e.g., Situation (1)) or the COT of those selected resource can be shared to the reserved SL-PRS resource of another UE (e.g., Situation (2)). In Situation (1), one or more resources (if more than one resource, consecutive resources) after a reserved SL-PRS resource when the LBT time of those one or more selected resources overlap with the transmission duration of the reserved SL-PRS resource. In Situation (2), one or more resources (if more than one resource, consecutive resources) before a high-priority reserved SL-PRS resource, high-priority means either the transmission priority of SL-PRS is high (value is small) or the CAPC of this reserved SL-PRS transmission is low.

In some arrangements, the method 400 further includes determining, by the first UE 104a, resources for transmitting the SL-PRS within a selection window, determining, by the first UE, LBT failure on a first resource of the resources or a first resource of the resources blocks a high-priority SL-PRS resource reserved by another UE, and determining, by the first UE, that the first resource of the resources has a first priority lower than a second priority of a second resource without the LBT failure. In some arrangements, the method 400 further includes determining, by the first UE, candidate resources for transmitting the SL-PRS within a selection window based on at least one of sensing results for the candidate resources, COT sharing condition, and LBT blocking.

Some arrangements relate to SCI monitoring and power saving. From Tx UE's perspective, the actual transmission time is not in a fixed location in the time domain due to the potential LBT failure. To increase the probability of LBT success for Tx UE, one SL-PRS resource can have two or more candidate transmission occasions. For either dedicated resource pool or shared resource pool, a SL-PRS resource refers to a time-frequency resource within a slot that is used for SL-PRS transmission.

FIG. 26 illustrates an example configuration 2600 of multiple transmission occasions for one SL-PRS resource, according to some arrangements. As shown in FIG. 26, a Tx UE is configured with SL-PRS resource 1 with a resource reservation period 2610 or periodicity. Within a resource reservation period 2610, two or more candidate transmission occasions 2620 of SL-PRS1 are allowed. The number of SL-PRS transmission occasions can be determined according to configuration or pre-configuration. Multiple SL-PRS transmission occasions of a SL-PRS resource can be within a single slot or located in different slots. In some examples, the method 400 includes determining, by the first UE, two or more candidate transmission occasions for transmitting the SL-PRS, the two or more candidate transmission occasions are within one slot or within different slots.

In some examples in which multiple SL-PRS transmission occasions of a UE are configured or pre-configured within a single slot, multiple SL-PRS resources within a single slot can be configured to the UE 104a where the SL-PRS resources have different starting symbols or/and different SL-PRS resource IDs. One or more characteristics for those multiple SL-PRS resources such as SL-PRS comb offset, comb size, SL-PRS frequency domain allocation (e.g., SL-PRS bandwidth) and so on can be the same.

In some examples in which multiple SL-PRS transmission occasions of a UE are configured or pre-configured within a single slot, a UE is configured with a single SL-PRS resource within a slot where this SL-PRS can be associated with two or more candidate starting symbols.

In some examples, the method 400 includes determining, by the first UE, two or more candidate resources within a slot for transmitting the SL-PRS. The two or more candidate resources have at least one of different starting times or resource IDs. The two or more candidate resources have at least one of a same comb offset, a same comb size, a same frequency-domain allocation. In some examples, the method 400 includes determining, by the UE, a candidate resource within a slot for transmitting the SL-PRS. The SL-PRS has two or more candidate starting times.

In some examples in which a Tx UE can access the channel on either the slot boundary or in the middle of a slot, Rx UEs need to frequently monitor SCI/PSCCH in case that Tx UE's SL-PRS transmission is intended for the Rx UE. It is power-consuming for Rx UE in this situation. For UEs in SL communication or SL positioning in licensed band, UEs only needs to monitor SCI/PSCCH at the fixed location (e.g., the first two or three symbols except the Automatic Gain Control (AGC) symbol at the start of a slot) of a slot. For SL-U positioning, Rx UEs monitors SCI/PSCCH in a sub-slot granularity.

Some arrangements relate to reducing potential power consumption. In the examples in which the UE 104b has already received N SL-PRS (N occasions of the same SL-PRS resource or multiple SL-PRS resources depending on configuration), the UE 104b assumes or determines that a Tx UE's LBT procedure (e.g., the LBT procedure of the UE 104a) is successful and stops monitoring the SCI that is associated with Tx UE's SL-PRS transmission. The value of N can be configured or preconfigured. The BS 102 or the LMF can send the value N to the UE 104a via RRC or LPP respectively. The UE 104a can also receive the value N from another UE (e.g., the third UE) via SLPP or SCI. In some arrangements, in the method 400, the second UE determines that an LBT procedure is successful and stops monitoring SL-PRSs in response to receiving a number of the SL-PRSs from the first wireless communication wireless device, the number can be configured by a BS, an LMF, or a third UE.

In some examples, the UE can switch the SCI/PSCCH monitoring granularity (e.g. slot-based SCI monitoring or sub-slot-based SCI motoring).

In some examples, the second UE (e.g., Rx UE) can maintain frequent SCI/PSCCH monitoring until it receives another UE's (e.g., Tx UE or the first UE) SCI/PSCCH. The Tx UE's SCI/PSCCH can include a window configuration where Rx UE can use sparse SCI/PSCCH monitoring (e.g., per slot SCI monitoring instead of sub-slot SCI monitoring). This window configuration includes the starting location and its duration. The staring location can be the location where Rx UE receives the SCI or an additional offset.

In some examples, the second UE (e.g., Rx UE) use frequent SCI/PSCCH monitoring (e.g. sub-slot monitoring) outside a window and use a sparse SCI/PSCCH monitoring (per slot monitoring or even across slot monitoring) within the window. The window can be a COT duration.

In some examples, SCI monitoring granularity can be implemented based on SCI/PSCCH monitoring. In a slot, once the Rx UE monitors one PSCCH (where the source/destination ID can match), the Rx UE switches to sparse SCI/PSCCH monitoring. SCI can include 1-bit indicating whether Rx UE should switch SCI/PSCCH monitoring granularity. This SCI can be the same as the SCI which contains COT sharing information. The SCI can be either unicast, groupcast, or broadcast. For example, for UL-like SL-TDOA, a target UE can transmit SL-PRS resource(s) to multiple UEs.

In some examples, SCI monitoring granularity can be implemented only when Rx UE correctly receives PSCCH and the associated SL-PRS resource. In response, the Rx UE switches SCI/PSCCH monitoring granularity. In some examples, SCI monitoring granularity can be implemented using a timer configured or pre-configured to the Rx UE. The timer can be configured by either BS via RRC/DCI, LMF via LPP, or UE via SLPP/SCI. In response to determining that the Rx UE maintaining sparse SCI/PSCCH monitoring for a certain time, the Rx UE autonomously switches back to frequent SCI/PSCCH monitoring. In some examples, SCI monitoring granularity can be implemented such that in response to receiving the SCI's reservation information, the Rx UE switches to sparse SCI/PSCCH monitoring.

From UE capability perspective, a UE can report its capability on whether it support SCI/PSCCH monitoring granularity switching. A UE can report whether it supports a timer described herein. In response to a UE receiving a switch indication, it takes time for UE to process and actual switch the granularity. The UE can report this processing time (if its unit is slot or symbol then it is associated with SCS) to the network.

In some arrangements, in the method 400, the second UE (e.g., the Rx UE or the UE 104b) switches a granularity for monitoring SCI or the PSCCH. In some examples, the second UE switches the granularity in response to receiving the SCI or the PSCCH from the first UE. In some examples, the second UE monitors the SCI or the PSCCH in a frequent granularity outside of a monitoring window and a sparse granularity within the monitoring window.

Some arrangements relate to positioning power saving NR-U. For DL positioning, even in RRC_INACTIVE or RRC_IDLE state, the UE 104b needs to wake up and receive every DL-PRS resources as indicated by LMF, which will cause large ramp-up and ramp-down power consumption. In order to increase the probability of successfully transmitting DL-PRS, the repetition factor (e.g., dl-PRS-ResourceRepetitionFactor) can be configured to be a larger value, for example, the repetition factor is configured to be greater than 32.

In some examples, a multiplier number can be configured on the basis of regular repetition factor, the time gap between two consecutive SL-PRS resource's repetition is also decrease by 1/(a multiplier number).

The UE can send on-demand DL-PRS request to LMF requesting for repetition factor greater than 32 in NR-U. The LMF can also initiate an on-demand DL-PRS request for larger repetition factor. A larger repetition factor can guarantee that at least X transmission occasions of a DL-PRS resource are successfully transmitted. The number of X can be related to the number of samples.

In some arrangements, in RRC_INACTIVE or RRC_IDLE state, if a UE has already received N DL-PRS (N occasions of the same DL-PRS resource), the UE assumes BS's LBT procedure is successful and stops monitoring DL-PRS. The value of N can be configured or pre-configured. The BS 102 or the LMF can send the value N to the UE via RRC or LPP respectively. The value of N is determined by the UE itself, for example, using the number of samples as a reference. For example, at least N is larger than the number of samples.

In some arrangements, in RRC_INACTIVE or RRC_IDLE state, the UE receives the message “stop monitoring DL-PRS or stop measuring DL-PRS” from the BS 102 via short messages. The BS 102 itself has knowledge about whether the BS 102 has accessed the channel and transmitted DL-PRS.

In some arrangements, the LMF can indicate UE to stop monitoring or measuring DL-PRS via LPP.

FIG. 27 is a flowchart diagram illustrating an example method 2700 for performing power saving for NR-U, according to some arrangements. The method 2700 can be performed using the system 100. At 2710, a UE receives from an LMF configuration for the DL-PRS. At 2720, the UE receives the DL-PRS according to the configuration. In some examples, the method 2700 further includes stop monitoring, by the UE, when in an RRC_INACTIVE mode or an RRC_IDLE mode, the DL-PRS in response to determining that a threshold number of DL-PRSs have been received. In some examples, the method 2700 further includes stop monitoring, by the UE, when in an RRC_INACTIVE mode or an RRC_IDLE mode, the DL-PRS in response to receiving a message from the BS or the LMF indicating to stop monitoring the DL-PRS.

While some arrangements of the present solution have been described above, it should be understood that they have been presented by way of example only, and not by way of limitation. Likewise, the various diagrams can depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which can be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules can be combined to form a single module that performs the associated functions according arrangements of the present solution.

Additionally, memory or other storage, as well as communication components, can be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains can be used without detracting from the present solution. For example, functionality illustrated to be performed by separate processing logic elements, or controllers, can be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
determining, by a first wireless communication device, a configuration for a sidelink (SL) positioning-related transmission, wherein the configuration designates at least one carrier for SL positioning and SL-Unlicensed (SL-U) positioning, each of the at least one carrier comprising one or more SL bandwidth parts (SL-BWPs); and
communicating, by the first wireless communication device with a second wireless communication device, the SL positioning-related transmission, wherein the SL positioning-related transmission comprises at least one of a Sidelink Positioning Reference Signal (SL-PRS), a Physical Shared Control Channel (PSCCH) corresponding to the SL PRS, or a Demodulation Reference Signal (DMRS).

2. The wireless communication method of claim 1, wherein the configuration is received by the first wireless communication device from at least one of
a Base Station (BS) via at least one of Resource Control (RRC) signaling, a Downlink Control Information (DCI), or a Medium Access Control (MAC) Control Element (CE);
a Location Management Function (LMF) via Long Term Evolution Positioning Protocol (LPP); or
the second wireless communication device or a third wireless communication device via at least one of Sidelink Positioning Protocol (SLPP), PC5-RRC signaling, SL MAC CE, or Sidelink Control Information (SCI), wherein the configuration comprising an idle period.

3. The wireless communication method of claim 1, wherein the configuration designates:
the at least one carrier for both SL positioning and SL-U positioning;
at least one resource pool configured with a SL-BWP; and
a resource for transmitting each of the at least one of the SL-PRS or the PSCCH within each of the at least one resource pool.

4. The wireless communication method of claim 1, wherein the configuration designates:
a first carrier for SL positioning and a second carrier for SL-U positioning, wherein the first carrier is different from the second carrier;
each of the first carrier and the second carrier comprises one or more SL-BWPs;
at least one resource pool configured with a SL-BWP; and
a resource for transmitting each of the at least one of the SL-PRS or the PSCCH within each of the at least one resource pool.

5. The wireless communication method of claim 1, wherein
the configuration designates that each resource for transmitting the SL-PRS occupies all interlaced Resource Blocks (RBs) of a resource pool; and
the SL-PRS has a comb-based structure.

6. The wireless communication method of claim 1, wherein the configuration designates one common interlace or subchannel and a plurality of dedicated Physical Resource Blocks (PRBs) for transmitting the PSCCH.

7. The wireless communication method of claim 6, wherein
the configuration comprises a number of the plurality of dedicated PRBs; and the configuration designates at least one of:
the plurality of dedicated PRBs are within a same Resource Block (RB) set;
the plurality of dedicated PRBs are within a same at least one interlace or subchannel; or
the plurality of dedicated PRBs comprises one or more interlaces or subchannels.

8. The wireless communication method of claim 6, wherein the configuration designates a mapping between the plurality of dedicated PRBs of the PSCCH and one or more resources for the SL-PRS, wherein the mapping comprises at least a location and a number of the plurality of dedicated PRBs of the PSCCH, an occupied interlace index of the PSCCH, an occupied sub-channel index of the PSCCH, an RB set index of the PSCCH, a vector type of the PSCCH, a vector length of the PSCCH, a vector index of the PSCCH, number of symbols for the PSCCH, a starting symbol of the PSCCH, a starting symbol of SL-PRS, number of symbols of SL-PRS, a starting PRB of SL-PRS, a comb size of SL-PRS, a resource bandwidth of SL-PRS, or a SL-PRS resource ID.

9. The wireless communication method of claim 1, wherein the configuration designates one or more dedicated interlaces or one or more dedicated sub-channels for transmitting the PSCCH.

10. The wireless communication method of claim 9, wherein the configuration designates that each resource for transmitting the PSCCH is mapped to one or more dedicated interlaces index or to one or more sub-channel index.

11. The wireless communication method of claim 9, wherein the configuration designates a length and an index of a vector for each of a plurality of wireless communication devices or for each resource for transmitting the PSCCH, wherein communicating the SL positioning-related transmission comprises repeating at least one of the PSCCH or a Demodulation Reference Signal (DMRS) corresponding to the PSCCH for a number of times equal to the length of the vector.

12. The wireless communication method of claim 11, wherein the configuration designates a Discrete Fourier Transform (DFT) vector for each of a plurality of wireless communication devices or for each resource for transmitting the PSCCH, wherein communicating the SL positioning-related transmission comprises multiplexing multiple resources for transmitting the PSCCH using PRB-level cyclic shift or Resource Element (RE)-level cyclic shift.

13. The wireless communication method of claim 11, wherein the configuration designates at least one of:
the vector is used for Frequency Domain Orthogonal Cover Code (FD-OCC), a plurality of wireless communication devices use a same interlace or a same subchannel;
the vector is used for Time Domain Orthogonal Cover Code (TD-OCC), a plurality of wireless communication devices use a same interlace or a same subchannel;
the plurality of wireless communication devices comprises the first wireless communication device;
each of the plurality of wireless communication devices is configured with an Orthogonal Cover Code (OCC) length and an OCC index; or
each resource for transmitting the PSCCH is mapped to an OCC length or an OCC index.

14. The wireless communication method of claim 13, wherein at least one of:
the first wireless communication device supports Resource Element (RE)-level FD-OCC within a PRB bundle wherein a PRB bundle includes an even number of PRBs;
the first wireless communication device supports RE-level FD-OCC, and the configuration designates a number of REs for DMRSs for each of the PRBs used to transmit the PSCCH is even; or
the first wireless communication device supports Resource Block (RB)-level FD-OCC for multiplexing the PSCCH.

15. The wireless communication method of claim 9, wherein the configuration comprises a mapping between one or more interlace index of PSCCH and one or more resources for transmitting the SL-PRS, wherein the mapping comprises an OCC type, an OCC length, an OCC index, one or more occupied interlace index of the PSCCH, one or more occupied sub-channel index of the PSCCH, one or more RB set index of the PSCCH, a vector type of the PSCCH, a vector length of the PSCCH, a vector index of the PSCCH, number of symbols for the PSCCH, a starting symbol of the PSCCH, a starting symbol of SL-PRS, number of symbols of SL-PRS, a starting PRB of SL-PRS, a comb size of SL-PRS, a resource bandwidth of SL-PRS, or a SL-PRS resource ID.

16. The wireless communication method of claim 1, wherein the configuration designates that:
each PSCCH transmission occupies one or more dedicated Physical Resource Blocks (PRBs) or one or more common PRBs; and
the common PRBs comprises a starting PRB and an ending PRB of each Resource Block (RB) set.

17. The wireless communication method of claim 1, wherein the configuration designates that:
each PSCCH transmission occupies a partial interlace or a sub-interlace for each of one or more interlaces, wherein each of a plurality of wireless communication devices use a part of same interlace, the plurality of wireless communication devices comprises the first wireless communication device; and
the partial interlace is a Resource Block (RB)-level partial interlace or a Resource Element (RE)-level partial interlace.

18. The wireless communication method of claim 1, wherein at least one of a number of Resource Block (RB) sets occupied by the PSCCH and a number Resource Block (RB) sets occupied by the SL-PRS are same or different;
resources for transmitting the PSCCH are in two or more different RB sets; or
the resources for transmitting the PSCCH are Frequency Domain Multiplexed (FDMed) in a granularity of the RB set.

19. The wireless communication method of claim 1, wherein the configuration designates each resource for transmitting the PSCCH comprises continuous Resource Blocks (RBs).

20. A wireless communication device, comprising:
at least one processor configured to:
determine configuration for a sidelink (SL) positioning-related transmission, wherein the configuration designates at least one carrier for SL positioning and SL-Unlicensed (SL-U) positioning, each of the at least one carrier comprising one or more SL bandwidth parts (SL-BWPs); and
communicate, via a transceiver with a second wireless communication device, the SL positioning-related transmission, wherein the SL positioning-related transmission comprises at least one of a Sidelink Positioning Reference Signal (SL-PRS), a Physical Shared Control Channel (PSCCH) corresponding to the SL PRS, or a Demodulation Reference Signal (DMRS).
